(19) United States
(12) Patent Application Publication
(10) Pub. No.: US 2025/0256459 A1
(43) Pub. Date: Aug. 14, 2025

(54) THREE DIMENSIONAL PRINTING CONTROL

(71) Applicant: Chromatic 3D Materials Inc., Golden Valley, MN (US)

(72) Inventors: Cora Leibig, Maple Grove, MN (US); Daniel Gilbert, Richfield, MN (US); Paul Hopkins, Savage, MN (US); Michael Garrod, Minnetrista, MN (US)

(73) Assignee: Chromatic 3D Materials Inc., Golden Valley, MN (US)

(21) Appl. No.: 19/019,634

(22) Filed: Jan. 14, 2025

Related U.S. Application Data
(63) Continuation-in-part of application No. 18/749,019, filed on Jun. 20, 2024.
Application No. 18/749,019 is a continuation of application No. 18/327,177, filed on Jun. 1, 2023, now Pat. No. 12,036,738.
Application No. 18/327,177 is a continuation of application No. 17/225,377, filed on Apr. 8, 2021, now Pat. No. 11,724,458.
Application No. 17/225,377 is a continuation of application No. 16/433,324, filed on Jun. 6, 2019, now Pat. No. 11,065,816.

(51) Int. Cl. B29C 64/336; B29C 64/106; B29C 64/118; B29C 64/209; B29C 64/321; B29C 64/393; B29C 67/24; B29K 75/00; B29K 101/10; B29K 105/00; B29K 105/04; B33Y 10/00; B33Y 70/10; B33Y 80/00

(52) U.S. Cl. CPC B29C 64/336; B29C 64/106; B29C 64/118; B29C 64/209; B29C 64/321; B29C 64/393; B29C 67/246; B33Y 10/00; B33Y 70/10; B33Y 80/00; B29K 2075/00; B29K 2101/10; B29K 2105/0002; B29K 2105/0094; B29K 2105/04

(57) ABSTRACT

A three-dimensional (3D) object production system and methods for 3D printing reactive components to form a thermoset product. The disclosure relates to use of a 3D printer having a controller comprising one or more processors to print a 3D object. The disclosure also provides a 3D object production system and methods for 3D printing comprising adjusting one or more parameters of an at least one actuator to produce a 3D object based on a reaction rate between reactive components. It may be described that the exemplary systems and methods described herein may control, or adjust, various part properties by controlling, or modifying one or more of a plurality of reactive components to provide a thermoset product for use in 3D printing.

### CROSS-REFERENCE TO RELATED APPLICATIONS

This application is a continuation-in-part application claiming the benefit of U.S. non-provisional patent application Ser. No. 18/749,019 filed on Jun. 20, 2023, and U.S. non-provisional patent application Ser. No. 17/677,979 filed on Feb. 22, 2022. U.S. non-provisional patent application Ser. No. 18/749,019 is a continuation of U.S. non-provisional patent application Ser. No. 18/327,177 filed on Jun. 1, 2023, which is a continuation of U.S. non-provisional patent application Ser. No. 17/225,377 filed on Apr. 8, 2021, for which U.S. Pat. No. 11,724,458 was granted on Aug. 15, 2023, which is a continuation of U.S. non-provisional patent application Ser. No. 16/433,324 filed on Jun. 6, 2019, for which U.S. Pat. No. 11,065,816 was granted on Jul. 20, 2021, which is a continuation of international patent application no. PCT/US2017/064941 filed on Dec. 6, 2017, which claims priority based on U.S. provisional patent application No. 62/430,919, filed on Dec. 6, 2016, and U.S. provisional patent application No. 62/524,214, filed Jun. 23, 2017. U.S. non-provisional patent application Ser. No. 17/677,979 is a continuation of U.S. non-provisional patent application Ser. No. 16/749,671 filed on Jan. 22, 2020, for which U.S. Pat. No. 11,254,047 was granted on Feb. 22, 2022, which is a continuation of U.S. non-provisional patent application Ser. No. 16/256,657 filed on Jan. 24, 2019, for which U.S. Pat. No. 10,639,842 was granted on May 5, 2020, which is a continuation of international patent application no. PCT/US2018/064323 filed on Dec. 6, 2018, which claims priority based on U.S. provisional application No. 62/595,400 filed on 6 Dec. 2017. The content of each of the above-identified patent applications is fully incorporated herein by reference.

### TECHNICAL FIELD OF THE INVENTION

The disclosure herein relates to three-dimensional printing control methods and processes, and further to systems, devices, and apparatus for performing and implementing such methods and processes. The disclosure also relates to using a controller to control a viscosity, a degree of polymerization, and an aspect ratio of a thermoset product and print a 3D object based on control of the viscosity, degree of polymerization, and aspect ratio. This invention includes, but is not limited to, to formulations and methods for three dimensional printing using thermoset compositions such as, but not limited to, polyurethane.

### BACKGROUND

Fused filament fabrication (FFF), also referred to in the art as thermoplastic extrusion, plastic jet printing (PJP), fused filament method (FFM), or fusion deposition modeling, is an additive manufacturing process wherein a material is extruded in successive layers onto a platform to form a 3-dimensional product. Typically, FFF uses a melted thermoplastic material that is extruded onto a lower-temperature platform. Three-dimensional printing (3D printing) often uses support structures which are easily dissolved or removed from the part after it is finished.

Disadvantages of existing FFF technology using thermoplastics include single material property printing, limited print-direction strength, limited durability, and limited softness. Thermosetting materials have generally not been used in FFF because prior to cure, the monomers are low viscosity liquids, and upon deposition, the curing liquid flows or breaks into droplets, resulting in finished parts of low quality and undesirably low resolution. In practice, attempts to print with thermoset materials has required addition of fillers (such as inorganic powders or polymers) to induce thixotropic behavior in the resin before it is fully cured. These solutions affect the final properties of the printed part. Other problems include poor resolution control in the printed part and frequent clogging of mixing systems.

### SUMMARY

It may be described that the exemplary systems and methods described herein may control, or adjust, various part properties by controlling, or modifying one or more of a plurality of reactive components to provide a thermoset product for use in 3D printing. For example, a proportion of flow from isocyanate sources based on isocyanate attributes may be used to control part flexibility, color, optical refractive index, etc. (for instance, more specifically, smaller molecular weight (Mw) may provide, or give, more rigid materials, higher Mw give more flexible materials).

Further, for example, a proportion of flow from polyol sources based on polyol attributes may be used to control part flexibility, color, optical refractive index, etc. (for instance, more specifically, smaller molecular weight may give, or provide, more rigid materials, higher Mw give more flexible materials). Still further, for example, a proportion of flow from a gas-generation source, such as a blowing agent or reactive species that generates gas may be used to control part porosity or density (e.g., to create a controlled “foam”).

It may be described that the exemplary systems and methods may include or utilize various extruded thermoset printing apparatus to monitor/fix various issues, control various parameters, or control environmental conditions when generating or creating 3D objects. For example, the extruded thermoset printing apparatus may be configured to detect obstruction in the print flow tubing/nozzle by detecting torque on the motors (e.g., using torque upper limits to detect viscosities that are out of the operating range), monitoring the flow within the tubing, and/or pressure within the printing apparatus. Detection of an obstruction may trigger change or cleaning of the mixing system. Further, for example, a mixing quality may be detected, or determined (e.g., using metering pumps to ensure the right ratios of materials are being mixed together or chemical analysis), as material exits the printhead, such as by a color detection or chemical detection, which may then be used to delay deposition of material on part, purge material into a purge area until mixing is achieved, and/or warn a user. Still further, for example, the pressure of each resin may be detected, and motor displacement may be controlled as necessary to achieve desired material flow rate or stop flow. In other words, the exemplary systems and methods may use pressure feedback to monitor actual volume flow to compare against calculated volume flow. Still further, for example, flow of the various reactive components or resultant thermoset product may be monitored. More specifically, flow feedback may be used to monitor actual volume flow to compare against calculated volume flow. Still further, for example, weight of the 3D object be printed, or created, may be monitored, and used in various control processes. In other words, the printing apparatus may be configured to detect the weight of the print and that the amount pumping is keeping up with the program desired amount. Further, the amount of material exiting onto the platform may be verified to match the theoretical amount such that, e.g., corrections or adjustments can be made. Still further, for example, pressure may be adapted for container diameter. More specifically, a sensing system may be used to compensate for the gradient of pressure needed across different sized vessels during printing of the reactive materials, and another measuring device would ensure consistent flow.

And still further, for example, the printing apparatus may include a tip wiping mechanism to clean tip to prevent glob formation and drag. More specifically, the tip wipe may have a ‘clean’ area to wipe the tip of the nozzle clean. Since the polyurethane will cure and harden, there must be a ‘clean’ area to wipe. Further, the tip wipe may be replaceable.

Yet still further, the printing apparatus may provide, or include, a humidity controlled cabinet to control moisture that leads to part quality. The humidity controlled cabinet may have an internal or external active system to remove moisture. Further, the controlled cabinet may have at least two functions: remove the moisture to help build parts and create a narrower band wide of moisture (which may allow less testing of variables).

Still further, for example, the printing apparatus may provide, or include, a purge container (e.g., a bucket) to put purged material. Material may be purged at the beginning of a part or inside a part to keep the nozzle from locking up with curing materials.

Still further, for example, the printing apparatus may be able to control cabinet temperature. For instance, the cabinet may have sides and ceiling to contain the heated air. The temperature of the internal cabinet will help define the curing time of polyurethane. As the cabinet temperature raises, the polyurethane viscosity may increase, and the cure time may decrease. Also, raising the internal temperature, the environment temperature would be removed or reduced.

It may also be described that the exemplary systems and methods may control, or adjust, various print conditions to provide desired geometry and resulting part-filling of the strand placed on the part. For example, time per layer, flow rate through nozzle, viscosity at nozzle, and cure acceleration may be adjusted, or modified. Further, the temperature of the resin may affect viscosity change out of the nozzle and a faster reaction speed of the material. The conditions from the timing of the viscosity and reaction rate of the material may create a profile of the material which translates to the resulting physical and mechanical properties. Timing of the viscosity and reaction rate can affects the space-filling properties of the material. Proper space-filling can improve mechanical properties and control of the viscosity and flow rate can allow for faster printing without losing part resolution. Still further, for example, the increased temperature of the platform may create a lowering of viscosity and a quicker reaction speed of the material closest to the platform and may create a different viscosity and reactivity for the exiting material, especially for the base layers. Still further, for example, the temperature of the build volume may create a quicker reaction speed and start to speed the overall cure of the finished part. Still further, for example, temperature at the extrusion nozzle may also be able to alter the cure as it is deposited and resulting strand geometry, e.g., for quick reactive cure adjustments. And still further, for example, the humidity of the printing chambers may be used to control, or affect, the formation of bubble defects in a part.

It may also be described that the exemplary systems and methods may control, or adjust, various bead shapes of the thermoset product using nozzle diameter, height of the nozzle from the 3D object being printed, and nozzle tip shape. In general, the smaller the tip (ID) size, the better the part resolution. More specifically, the tip (ID) for the most part may define the maximum/minimum volume rate. In general, if the flow volume is smaller than the tip (ID) the out flow may “walk” between the edges of the tip (ID). If the flow volume creates a cross-section larger than the tip (OD), the material may flow up around the tip, creating a non-flat top surface. Further, the part definition may be defined by the support angle and the resolution of the part. Still further, bead formation may be flattened if desired. In general, the exemplary systems and methods may affect the ability to shape the top of the bead.

It may also be described that the exemplary systems and methods may control, or adjust, various tool path controls. For example, the translation path for each layer may control the flow and resolution of the printed part. At the end of segment/contour, the tip may be moved to the next segment/contour, and the exemplary systems and methods may move to the next position by changed flowing (e.g., reduced or stopped flow). The creation of the toolpath should be such that the start of the next segment/contour should be as close as possible. Further, for example, the exemplary systems and methods may control whether to use a parallel or perpendicular pattern to controls the resulting strength isotropy of the part. Further, stress-strain results may be used to modify the generated toolpath to return the “strongest” or “more flexible’ toolpath based on the collected data from the strength tests. Still further, for example, the time per layer may control time to harden previous layer. There will be a “minimum layer time,” which may be defined as the minimum amount of time it takes to partially cure or gel a layer of polyurethane of given volume. If the next layer is printed before this minimum time, then the previous layer may deform by the weight of the current layer, and the exemplary systems and methods may adjust head speed in view thereof. And still further, the stoichiometry and/or ratio of reactive components, or specie, may further be used to control part quality. Yet still further, the exemplary systems and methods may be used to control the seams of the 3D object (“seam control”). More specifically, the seams may be reduced by overlapping or hiding the seams on the inside of the 3D object by using different Z, or height, levels at start and stop of a layer or path. Further, the start/end of the toolpath may be a given issue, and the start/end flow may be equal to the constant flow cross-section to, e.g., potentially avoid flaws. The start/end segment can overlap but there may be a change in the volume. A potential seam flaw can be reduced hiding part or all of the start/end segments inside the part. If the seam is internal, then the toolpath may avoid this volume when filling the part, and the seam segment can be moved in Z, or height dimension, to reduce the fill volume (e.g., start lower in z, raise to layer height, then reduce the volume flow over the end segment).

Still further, for example, the exemplary systems and methods may include, or provide, automatic nozzle cleaning to allow cleaning between layers and/or to clean off the buildup on the tip. The automatic cleaning can be timed or would be controlled with smart technology (e.g., recognized by a sensor). Thus, any collected material on the tip may be removed before it becomes fully or near cured. In at least one embodiment, the tip wipe could be made of a material that polyurethane does not stick to. (e.g., Silicone).

Still further, for example, the exemplary systems and methods may include, or provide, speed control including acceleration. More specifically, the controller may have independent control of all axes (X,Y,Z) and may also have control of head volume flow. The control of the volume flow of the resin/polyethene may not be the same as the X,Y,Z axes, and thus, the controller may start the resin/pu flow before/after the start of the X,Y,Z axes movement. Also, the acceleration/de-acceleration may be different for each or all of the axes and may be controlled to create a desired consistent volume flow

And still further, for example, the exemplary systems and methods may include, or provide corner speed control to, e.g., control the definition of the corner areas. To create a higher speed print, longer segments (e.g., longer, straighter segments) may have a higher print speed than corners. The controller may control all the axes to create a smooth and consistent volume flow through the corner.

### BRIEF DESCRIPTION OF THE DRAWINGS

FIG. 1 is a block diagram of an exemplary 3D object production system.

FIG. 2 is a block diagram of extruded thermoset printing apparatus of the system of FIG. 1.

FIG. 3 is a block diagram of an exemplary 3D object production system.

FIG. 4 is a printed 3D object having two different thermoset components.

FIG. 5 is a block diagram of an exemplary 3D object production system.

FIG. 6 is an extruder capable of combining up to 8 reactive components.

FIG. 7 is an extruder and extrusion nozzle.

FIG. 8 shows a cross section of three beads.

FIG. 9 is a pyramid shaped 3D printed object.

FIG. 10 is a computer diagram of a flattened donut.

FIG. 11 is a 3D printed flattened donut.

FIG. 12 shows a schematic of a polymer chemistry approach for developing 3D printable polyurethane precursors for production of non-foams. With conventional polyurethane foam precursor formulas, the initial viscosity is too low to print. As described herein, reaction components can be pre-reacted to form a high viscosity, printable formula and create a broad processing window for printing.

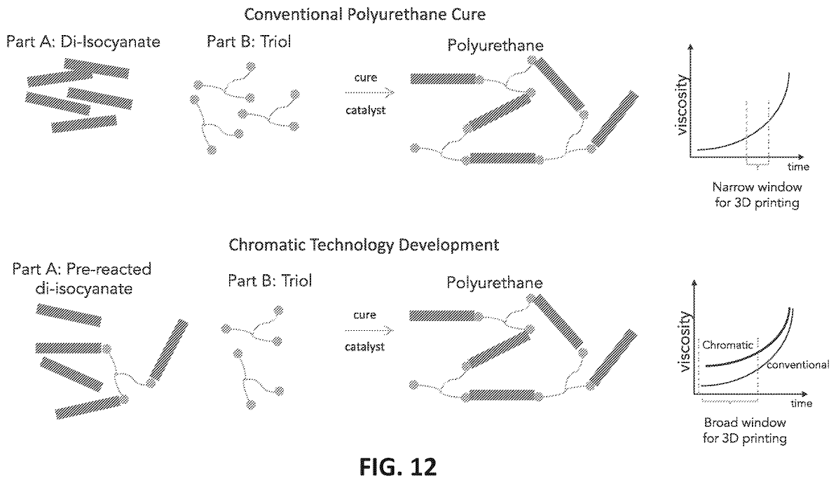

FIG. 13 shows the viscosity growth of the TDI-based formula (top left trace) and the MDI-based formula (bottom right trace). Viscometer settings: 22 C, spindle 27, 0.3 RPM.

FIG. 14 shows the viscosity growth of the slow formula system of Example 19.

FIG. 15 shows a fast formula processing window. The values in columns 1, 2, 3, 4, 5, and 6 refer to a flow rate of millimeters per minute (mm/min).

FIG. 16 shows a slow formula processing window. The values in the columns 1, 2, 3, and 4 refer to a flow rate of millimeters per minute (mm/min).

FIG. 17 shows a 3D object created as described in Example 20.

### DETAILED DESCRIPTION OF EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

Various examples and embodiments of the inventive subject matter disclosed here are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

### Definitions

The additive manufacturing process described herein can be referred to as extruded thermoset printing (ETP).

As used herein, a “reactive component” refers to a composition that includes at least one chemical that can react with another chemical to result in a thermoset product. In one embodiment, a reaction described herein includes mixing a first reactive component with a second reactive component to result in a thermoset product. A “reactive component” can also, and typically does, include one or more components that do not react to result a thermoset product. Thus, it is understood that not all “reactive components” are reactive per se. Non-limiting examples of components that do not react to result a thermoset product include certain additives (e.g., certain catalysts), a solvent, and the like.

As used herein, the terms “thermoset,” “thermoset product,” and “thermoset material” are used interchangeably and refer to the reaction product of at least two chemicals which form a covalently bonded crosslinked or polymeric network. In contrast to thermoplastics, a thermoset product described herein may irreversibly solidify or set.

In certain embodiments, a solid polymer, (e.g., a polyurethane) described herein is an elastomer. An elastomer is a polymer (e.g., a polyurethane) that is deformable when stress is applied, but retains its original shape after the stress is removed.

As used herein, the term “layer” refers to a strand of thermoset product that has been extruded from an extrusion nozzle and deposited on, for instance, a substrate. A layer is initially a partially reacted thermoset product, and cures to become a completely reacted thermoset product.

As used herein, the term “partially reacted thermoset product” refers to a covalently bonded crosslinked or polymeric network that is still reactive, e.g., it still has hydroxyl, amine, and/or isocyanate functionality that gives a measurable hydroxyl number, NH number, or NCO number in a titration. In another embodiment, a partially reacted thermoset product is a thermoset product that has a viscosity below 3,000,000 cp. In one embodiment, a partially reacted thermoset product is a thermoset product that has a molecular weight of no greater than 100,000 g/mol. A completely reacted thermoset product is a covalently bonded crosslinked or polymeric network that has no measurable reactive groups (e.g., hydroxyl, amine, or isocyanate functionality). In another embodiment, a completely reacted thermoset product is one that is a solid and has no measurable viscosity.

Layer resolution is the profile, (e.g., height) for a layer. For instance, extruding a layer from a nozzle having a diameter of 1 millimeter (mm) results in a layer resolution that is 1 millimeter (e.g., 1 millimeter height). As used herein, the term “predetermined layer resolution” refers to the height of a layer and can be based on the height of the nozzle above the printing substrate and the size of the nozzle used to extrude the layer. A “predetermined layer resolution” includes a tolerance for spreading of a layer after the layer of thermoset product is extruded from a nozzle. Spreading of a layer after it is deposited on a substrate or another layer may, in some embodiments, result in a decrease of the height of the layer from the time it is deposited on the substrate. In one embodiment, a layer can spread so that the height of the layer decreases by no greater than 1%, no greater than 5%, no greater than 10%, no greater than 15%, no greater than 20%, no greater than 25%, no greater than 30%, no greater than 50%, or no greater than 75% of height of the layer when extruded. For instance, a layer having a height of 1 mm can spread so that the height of the layer decreases by no greater than 5%, resulting in layer that is 0.95 mm to 1 mm in height. The amount of spreading is determined when the thermoset of a layer is completely reacted. The predetermined layer resolution can be controlled by the height of the nozzle above the substrate, by the nozzle diameter, or a combination thereof. In one embodiment, the predetermined layer resolution is controlled by the smaller of the height of the nozzle above the substrate or the nozzle diameter. Suitable nozzles include but are not limited to those having an inner diameter at the tip of 0.01 to 2 mm, or having an equivalent cross-sectional area when a nozzle is used that is not round.

As used herein, the term “predetermined shape resolution” refers to the shape of a three dimensional object (3D object) made using a method described herein.

The term “and/or” means one or all of the listed elements or a combination of any two or more of the listed elements.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

The articles “a,” “an,” and “the” are used herein to refer to one or more than one (i.e., to at least one) of the grammatical object of the article. By way of example, “an element” means one element or more than one element. Unless otherwise specified, “a,” “an,” “the,” and “at least one” are used interchangeably and mean one or more than one.

As used herein, the term “about” means±10% of the noted value. By way of example only, a composition comprising “about 30 wt. %” of a compound could include from 27 wt. % of the compound up to and including 33 wt. % of the compound.

Also herein, the recitations of numerical ranges by endpoints include all numbers subsumed within that range (e.g., 1 to 5 includes 1, 1.5, 2, 2.75, 3, 3.80, 4, 5, etc.).

The terms “comprises” and variations thereof do not have a limiting meaning where these terms appear in the description and claims. The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

It is understood that wherever embodiments are described herein with the language “include,” “includes,” or “including,” and the like, otherwise analogous embodiments described in terms of “consisting of” and/or “consisting essentially of” are also provided.

As used herein, the terms “thermoset,” “thermoset product,” and “thermoset material” are used interchangeably and refer to the reaction product of at least two chemicals which form a covalently bonded crosslinked or polymeric network. In contrast to thermoplastics, a thermoset product described herein may irreversibly solidify or set.

As used herein, the term “elastomer” means a polymer (e.g., a polyurethane) that is deformable when stress is applied, but retains its original shape after the stress is removed.

As used herein, the term “layer” refers to a strand of thermoset product that has been extruded from an extrusion nozzle and deposited on, for instance, a substrate. A layer is initially a partially reacted thermoset product, and cures to become a completely reacted thermoset product.

As used herein, the term “partially reacted thermoset product” refers to a covalently bonded crosslinked or polymeric network that is still reactive. For example, it still has hydroxyl, amine, and/or isocyanate functionality that gives a measureable hydroxyl number, NH number, or NCO number in a titration. In another embodiment, a partially reacted thermoset product is a thermoset product that has a viscosity below 3,000,000 cp. In one embodiment, a partially reacted thermoset product is a thermoset product that has a molecular weight of no greater than 100,000 g/mol.

As used herein, the term “completely reacted thermoset product” means a covalently bonded crosslinked or polymeric network that has no measurable reactive groups (e.g., hydroxyl, amine, or isocyanate functionality). In another embodiment, a completely reacted thermoset product is one that is a solid and has no measurable viscosity.

As used herein, the term “environmental parameter” means one or more of temperature, moisture level, and humidity.

### EXEMPLARY EMBODIMENTS

The present disclosure provides methods that use the principles of computer-generated graphics to simultaneously execute CAD and CAM, and to produce 3D objects directly from computer instructions. Such methods can be used to sculpture models and prototypes in a design phase of product development, or as a manufacturing tool, or even to produce art forms.

In the extruded thermoset printing (ETP) method of the present disclosure the generation of individual solid or foam laminae (also referred to herein as layers) representing cross-sections of a 3D object is accomplished. The successively formed adjacent layers form the desired 3D object which has been programmed into the system. Hence, the system of the present disclosure generates 3D objects by extruding material in a pattern according to a cross-sectional pattern of the object to be formed at a selected surface of a reactive thermoset composition, e.g., a surface of a partially reacted thermoset product. Successive adjacent layers, representing corresponding successive adjacent cross-sections of the object, are automatically formed and integrated together (e.g., crosslinked by covalent bonds) to provide a step-wise laminar or thin layer buildup of the object, whereby a 3D object is formed and drawn from successively deposited substantially planar or sheet-like surfaces of the fluid medium during the forming process, where the 3D object has a predetermined shape resolution.

Provided herein is a process and system for generating a 3D object by forming successive layers of curing thermoset material, each successive layer forming covalent bonds with, and adhering to, the previously deposited layer, to define the desired 3D object having a predetermined shape resolution. Many types of object forms can be created with the techniques described herein. Complex forms are more easily created by using the functions of a computer to help generate the programmed commands and to then send the program signals to the object forming subsystem. Open-source software packages for converting 3-dimensional objects from CAD files into “slicer” STL files for defining the layers of the object and software to control the printer are available to the skilled person and routinely used. Geometries of such complex forms are available which cannot be easily configured with molds. In one embodiment, the covalent bonds between layers consists of bonds formed between the partially reacted thermoset product, e.g., an adhesive is not added during the method and an adhesive does not exist between layers deposited during the creation of the object. In one embodiment, a complex geometry can be built in a single process step without first building multiple parts which must be assembled and joined together. In another embodiment, a part with regions of differing material properties can be built in a single process without first building multiple parts from varied materials and then assembled and joined together.

The computer in the system of the present disclosure has two basic functions. The first is to help the operator design the 3D object in a way that it can be made. The second is to translate the design into commands to control the robotic motion of the extruder tip, and to deliver these commands in a way so that the object is formed. In some applications, the object design will exist, and the only function of the computer will be to deliver the appropriate commands. The computer may also control the relative ratios of the reactive components in order to control the foam density and mechanical properties throughout the part. A 3D object produced using the methods described herein includes multiple layers. In one embodiment, the number of layers is at least 3, at least 5, at least 10, at least 20, at least 50, or at least 100.

A computer-controlled pump or pumps may be used to force reactive components through the mixing chamber and out of the extrusion nozzle. Likewise, appropriate level detection system and feedback networks, well known in the art, can be used to drive a fluid pump or a liquid displacement device to maintain reactive component volumes in the containers.

In addition, there may be additional containers used in the practice of the disclosure, each container having a different type of component, catalyst, water, pigments, and so on that can be selected by the system and added to the first or second reactive component before they are combined in the mixing chamber, or added to the mixing chamber separately. In this regard, the various materials might provide plastics of different colors, or have both insulating and conducting material available for the various layers of electronic products.

The present disclosure satisfies a long existing need in the art for a CAD and CAM system capable of rapidly, reliably, accurately and economically designing and fabricating three-dimensional plastic parts and the like from thermoset starting materials.

The process employs a fluid reactive composition including, but not limited to, first and second reactive components. The reactive composition is capable of forming thermoset compositions such as polyurethanes.

In one embodiment, the thermoset is a urethane and/or urea-containing polymer. In one embodiment, as used herein a “urethane and/or urea-containing polymer” is a polymer which contains urethane groups (—NH—(C═O)—O—) as part of the polymer chain. In general, a urethane linkage is formed by reacting isocyanate groups (—N═C═O) with hydroxyl groups (—OH). A polyurethane is produced by the reaction of an isocyanate containing at least two isocyanate groups per molecule with a compound having terminal hydroxyl groups. In one embodiment, an isocyanate having, on average, two isocyanate groups per molecule is reacted with a compound having, on average, at least two terminal hydroxyl groups per molecule.

In one embodiment, as used herein a “urethane and/or urea-containing polymer” is a polymer which contains urea groups (—NH—(C═O)—NH—) as part of the polymer chain. In general, a urea linkage is formed by reacting isocyanate groups (—N═C═O) with amine groups (e.g., —N(R′)₂), where each R′ is independently hydrogen or an aliphatic and/or cyclic group (typically a (C1-C4)alkyl group)). A polyurea is produced by the reaction of an isocyanate containing at least two isocyanate groups per molecule with a compound having terminal amine groups.

As used herein, “aliphatic group” refers to a saturated or unsaturated linear or branched hydrocarbon group. This term is used to encompass alkyl (e.g., —CH₃) (or alkylene if within a chain such as —CH₂—), alkenyl (or alkenylene if within a chain), and alkynyl (or alkynylene if within a chain) groups, for example. As used herein, “alkyl group” refers to a saturated linear or branched hydrocarbon group including, for example, methyl, ethyl, isopropyl, t-butyl, heptyl, dodecyl, octadecyl, amyl, 2-ethylhexyl, and the like. As used herein, “alkenyl group” refers to an unsaturated, linear or branched hydrocarbon group with one or more carbon-carbon double bonds, such as a vinyl group. As used herein, “alkynyl group” refers to an unsaturated, linear or branched hydrocarbon group with one or more carbon-carbon triple bonds. Unless otherwise indicated, an aliphatic group typically contains from 1 to 30 carbon atoms. In some embodiments, the aliphatic group contains 1 to 20 carbon atoms, 1 to 10 carbon atoms, 1 to 6 carbon atoms, 1 to 4 carbon atoms, or 1 to 3 carbon atoms.

As used herein, “cyclic group” refers to a closed ring hydrocarbon group that is classified as an alicyclic group, aromatic group, or heterocyclic group, and can optionally include an aliphatic group. As used herein, “alicyclic group” refers to a cyclic hydrocarbon group having properties resembling those of aliphatic groups. As used herein, “aromatic group” or “aryl group” refers to a mono- or polynuclear aromatic hydrocarbon group. As used herein, “heterocyclic group” refers to a closed ring hydrocarbon in which one or more of the atoms in the ring is an element other than carbon (e.g., nitrogen, oxygen, sulfur, etc.). Unless otherwise specified, a cyclic group often have 6 to 20 carbon atoms, 6 to 18 carbon atoms, 6 to 16 carbon atoms, 6 to 12 carbon atoms, or 6 to 10 carbon atoms.

In one embodiment, as used herein a “urethane and/or urea-containing polymer” is a polymer which contains both urethane and urea groups as part of the polymer chain. A polyurethane/polyurea is produced by the reaction of an isocyanate containing at least two isocyanate groups per molecule with a compound having terminal hydroxyl groups and a compound having terminal amine groups. In one embodiment, a polyurethane/polyurea is produced by the reaction of an isocyanate containing at least two isocyanate groups per molecule with a compound having terminal hydroxyl groups and terminal amine groups (e.g., a hydroxyl-amine such as 3-hydroxy-n-butylamine (CAS 114963-62-1)). Optionally and preferably, a reaction to make a polyurethane, a polyurea, or a polyurethane/polyurea includes other additives, including but not limited to, a catalyst, a chain extender, a curing agent, a surfactant, a pigment, or a combination thereof.

An isocyanate, which is typically considered a polyisocyanate, has the structure R—(N═C═O)ₙ, where n is at least 2, at least 3, at least 4, at least 5, at least 6, at least 7, or at least 8, and where R is an aliphatic and/or cyclic group. In one embodiment, an isocyanate has an n that is equivalent to n in Methylene diphenyl diisocyanate (MDI). In one embodiment, the isocyanate is a di-isocyanate (R—(N═C═O)₂ or (O═C═N)—R—(N═C═O)).

Examples of isocyanates include, but are not limited to, methylene diphenyl diisocyanate (MDI) and toluene diisocyanate (TDI). Examples of MDI include, but are not limited to, monomeric MDI, polymeric MDI, and isomers thereof. Examples of isomers of MDI having the chemical formula C₁₅H₁₀N₂O₂ include, but are not limited to, 2,2′-MDI, 2,4′-MDI, and 4,4′-MDI. Examples of isomers of TDI having the chemical formula C₉H₆N₂O₂ include, but are not limited to, 2,4-TDI and 2,6-TDI. Other examples of isocyanates include, but are not limited to, monomeric diisocyanates and blocked polyisocyanates. Examples of monomeric diisocyanates include, but are not limited to, hexamethylene diisocyanate (HDI), methylene dicyclohexyl diisocyanate or hydrogenated MDI (HMDI), and isophorone diisocyanate (IPDI). One example of a HDI is hexamethylene-1,6-diisocyanate. One example of a HMDI is dicyclohexylmethane-4,4′diisocyanate. Blocked polyisocyanates are typically based on HDI or IDPI. Examples of blocked polyisocyanates include, but are not limited to, HDI trimer, HDI biuret, HDI uretidione, and IPDI trimer.

Other examples of isocyanates that can be used for producing a thermoset described herein include, but are not limited to, aromatic diisocyanates, such as a mixture of 2,4- and 2,6-tolylene diisocyanates (TDI), diphenylmethane-4,4′-diisocyanate (MDI), naphthalene-1,5-diisocyanate (NDI), 3,3′-dimethyl-4,4′-biphenylene diisocyanate (TODI), crude TDI, polymethylenepolyphenyl isocyanurate, crude MDI, xylylene diisocyanate (XDI) and phenylene diisocyanate; aliphatic diisocyanates, such as 4,4′-methylene-biscyclohexyl diisocyanate (hydrogenated MDI), hexamethylene diisocyanate (HMDI), isophorone diisocyanate (IPDI) and cyclohexane diisocyanate (hydrogenated XDI); and modified products thereof, such as isocyanurates, carbodiimides and allophanamides.

A compound having terminal hydroxyl groups (R—(OH)ₙ), where n is at least 2 (referred to herein as “di-functional”), at least 3 (referred to herein as “tri-functional”), at least 4, at least 5, at least 6, at least 7, at least 8, at least 9, and no greater than 10, where R is an aliphatic and/or cyclic group, is referred to herein as a “polyol.” The skilled person will recognize that a polyol mixture will often include a small amount of mono-functional compounds having a single terminal hydroxyl group.

Examples of polyols include, but are not limited to, polyester polyols and polyether polyols. Examples of polyester polyols include, but are not limited to, those built from condensation of acids and alcohols. Specific examples include those built from phthalic anhydride and di-ethylene glycol, phthalic anhydride and di-propylene glycol, adipic acid and butane diol, or succinic acid and butane or hexane diol. The skilled person will recognize that many polyester polyols are semi-crystalline. Examples of polyether polyols include, but are not limited to, those built from polymerization of an oxide such as ethylene oxide, propylene oxide, or butylene oxide from an initiator such as glycerol, di-propylene glycol, TPG (tripropylene glycol), castor oil, sucrose, or sorbitol.

Other examples of polyols include, but are not limited to, polycarbonate polyols and lactone polyols such as polycaprolactone. In one embodiment, a compound having terminal hydroxyl groups (R—(OH)ₙ) has a molecular weight (calculated before incorporation of the compound having terminal hydroxyl groups into a polymer) of from 200 Daltons to 20,000 Daltons, such as from 200 Daltons to 10,000 Daltons.

A compound having terminal amine groups (e.g., R—(N(R′)₂)ₙ), where n is at least 2, at least 3, at least 4, at least 5, at least 6, at least 7, at least 8, at least 9, and no greater than 10, where R is an aliphatic and/or cyclic group, and where each R′ is independently hydrogen or an aliphatic and/or cyclic group (typically a (C1-C4)alkyl group), is referred to herein as a “polyamine.” The skilled person will recognize that a polyamine mixture will often include a small amount of mono-functional compounds having a single terminal amine group.

A suitable polyamine can be a diamine or triamine, and is preferably either a primary or secondary amine. In one embodiment, a compound having terminal amine groups has a molecular weight (calculated before incorporation of the compound having terminal hydroxyl groups into a polymer) of from 30 Daltons to 5000 Daltons, such as from 40 Daltons to 400 Daltons.

Examples of polyamines include, but are not limited to, diethyltoluene diamine, di-(methylthio)toluene diamine, 4,4′-methylenebis(2-chloroaniline), and chain extenders available under the trade names LONZACURE™ L15, LONZACURE™ M-CDEA, LONZACURE™ M-DEA, LONZACURE™ M-DIPA, LONZACURE™ M-MIPA, and LONZACURE™ DETDA.

Other examples of suitable polyamines include, but are not limited to, ethylene diamine, 1,2-diaminopropane, 1,4-diaminobutane, 1,3-diaminopentane, 1,6-diaminohexane, 2,5-diamino-2,5-dimethlhexane, 2,2,4- and/or 2,4,4-trimethyl-1,6-diaminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′ and/or 4,4′-diaminodicyclohexyl methane, and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,6-diaminotoluene and 2,4′ and/or 4,4′-diaminodiphenyl methane; and polyoxyalkylene polyamines.

Unless stated otherwise, the term “polyol and/or polyamine mixture” refers to a mixture of one or more polyols of varied molecular weights and functionalities, one or more polyamines of varied molecular weights and functionalities, or a combination of one or more polyols and one or more polyamines.

The present disclosure also provides the compositions described herein and a thermoset system comprising the compositions, e.g., a first reactive component and a second reactive component, and one or more optional reactive components, such as a third reactive component.

In one broad aspect, this disclosure provides a method of creating a three dimensional object from reactive components that form thermoset products using ETP, comprising: providing first and second reactive components which have molecular weights and viscosities that are effective to form a given part resolution, e.g., a predetermined layer resolution, during the method; introducing the first and second reactive components into a mixing chamber where mixing occurs and wherein the first and second reactive components have a residence time in the mixing chamber and/or extrusion nozzle effective to meet the desired predetermined layer resolution, wherein the first and second reactive components have a residence time in the mixing chamber insufficient to completely react, so that the mixture of the first and second reactive components forms a partially formed thermoset composition, e.g., a partially reacted thermoset product, in the mixing chamber; extruding the partially reacted thermoset product out of the mixing chamber through an extrusion nozzle and onto a substrate, such as a stage or a layer of previously formed and partially reacted thermoset product; and moving the extrusion nozzle and/or the substrate (relative to each other) to sequentially deposit layers of partially reacted thermoset product to form a 3D object having a predetermined shape resolution. In one embodiment, a partially reacted thermoset product is extruded out of the mixing chamber through an extrusion nozzle and onto a layer of previously formed and completely reacted thermoset product.

In one broad aspect, this disclosure provides a method of creating a 3D object from reactive components that form thermoset products using ETP, including: providing first and second reactive components that are effective to form a thermoset product having a predetermined layer resolution during the method; introducing the first and second reactive components into a mixing chamber where mixing occurs to form a mixture, wherein the first and second reactive components have a residence time in a mixing chamber effective to form a partially reacted thermoset product in the mixing chamber and result in the predetermined layer resolution upon exiting the mixing chamber, wherein the first and second reactive components have a residence time in the mixing chamber insufficient to completely react; extruding the partially reacted thermoset product out of the mixing chamber through an extrusion nozzle and onto a substrate, such as a stage or a layer of previously formed thermoset; and moving the extrusion nozzle and/or the substrate to form a 3D object having a predetermined shape resolution, wherein the layers of thermoset are deposited sequentially by moving the extrusion nozzle and/or the substrate to form a desired three dimensional object. In another broad respect, this disclosure provides an apparatus for creating a three-dimensional object from reactive components that form a thermoset product, comprising: an automatically moveable extrusion nozzle; first and second containers adapted for holding first and second reactive components; and a stage for receiving a partially reacted thermoset product resulting from the mixing of the first and second components. In one embodiment, the first and second components have molecular weights and viscosities that are effective to form a layer having a predetermined layer resolution for the three-dimensional object. In another embodiment, the first and second reactive components are effective to form a thermoset product having a predetermined layer resolution as it is extruded through an extrusion nozzle. Optionally, additional containers of reactive components may be incorporated in order to provide a wider range of final polymers; additional containers might also contain catalysts, water, or other reactants which can be varied. Optionally, an apparatus also permits control of the amounts of the first and second reactive components that are combined to form a thermoset product having a predetermined layer resolution. An apparatus useful herein also includes the ability to maintain a precise metering of the reactant components so that a ratio of the first and second reactive components, or additional reactive components (e.g., a third reactive component), are mixed. Altering the amounts of additional components, e.g., a third, fourth, or fifth component, during production of a 3D object can result in a 3D object having one or more properties vary between different areas of the 3D object. For instance, the hardness, density, durability, or a combination thereof, can change between two different areas of the 3D object.

The methods for making a thermoset product described herein, such as a urethane and/or urea-containing polymer thermoset product, include introducing first and second reactive components into a mixing chamber. In one embodiment, the first reactive component includes an isocyanate and the second reactive component includes a polyol and/or polyamine mixture. Thus, in one embodiment, the first reactive component includes an isocyanate and the second reactive component includes a polyol. In one embodiment, the first reactive component includes an isocyanate and the second reactive component includes a polyamine. In one embodiment, the first reactive component includes an isocyanate and the second reactive component includes a polyol and a polyamine. The first and second reactive components have certain characteristics including, but not limited to, viscosity, reactivity, and chemical compatibility.

In this disclosure, a thermoset product is made from reactive components that have viscosities and components having molecular weights such that they can be used to make a 3D object with the required object resolution. In another embodiment, the thermoset product is made from reactive components that are effective to form the thermoset product having a predetermined layer resolution upon extrusion from an extrusion nozzle.

In the practice of this disclosure, a mixing chamber is used with a configuration such that the two or more reactive components are intimately mixed, and with a residence time and optional catalyst level such that the reaction is extended far enough at the time of extrusion from an extrusion nozzle that the material can maintain the required resolution (e.g., the predetermined layer resolution). The reactive components can also be selected to facilitate mixing with minimal agitation (such as, but not limited to, use of static mixers) where the reactive components have similar characteristics, such as similar viscosities, similar chemical compatibility, or a combination thereof.

Viscosity refers to a measure of a fluid's resistance to gradual deformation by shear stress or tensile stress. In one embodiment, viscosity of a first reactive component and a viscosity of a second reactive component can be at least 60 centipoise (cP). Typically, a first reactive component and a second reactive component are formulated with prepolymers so that each component has a viscosity that is from 500 cp to 500,000 cp. In one embodiment, the viscosity range of each component is from 2,000 cp to 5,000 cp. While it is expected that there is no upper limit to viscosity, in one embodiment an upper limit may be no greater than 3,000,000 cp, no greater than 100,000 cp, or no greater than 50,000 cp. Viscosity is measured using a Brookfield viscometer using spindle 27, sample cup SC4-13RD, and at a rotational speed with a torque % between 10 and 90%. A person of ordinary skill in the art will also recognize that viscosity of a mixture can be further altered by including additives such as, but not limited to, thickeners, plasticizers, and solvents, or by changing temperature.

Chemical compatibility refers to the ability of the two reactive components to intimately mix and result in a homogenous mixture or solution. For instance, two aqueous solutions are chemically compatible, and two solutions of organic solvents are chemically compatible; however, an aqueous solution and an organic solvent are not chemically compatible.

There are two basic techniques that can be used to make a thermoset product described herein: a one-shot technique, and a prepolymer technique. In each technique, the combining of first and second reactive components results in a thermoset product with a viscosity that increases as reactants in the first and second reactive components react. The viscosity passes through a value that is low enough for the thermoset product to be extruded out of the mixing chamber and through an extrusion nozzle, and high enough for the thermoset product to have a predetermined layer resolution that is conducive for use in making a 3D object having a predetermined shape resolution.

In one embodiment, the prepolymer technique involves a first reaction between a composition including isocyanate and a composition including a polyol and/or polyamine mixture to produce a prepolymer. As used herein, a “prepolymer” includes, but is not limited to, a urethane and/or urea-containing polymer that results by reacting either polyol and/or polyamine mixture with an excess of isocyanate, or isocyanate with an excess of polyol and/or polyamine mixture. A prepolymer that results from reacting polyol and/or polyamine mixture with an excess of isocyanate is referred to herein as an “isocyanate prepolymer.” A prepolymer that results from reacting isocyanate with an excess of polyol and/or polyamine mixture is referred to herein as a “polyol and/or polyamine prepolymer.” More than one type of polyol can be used, more than one type of polyamine can be used, and more than one type of isocyanate can be used. In one embodiment, a composition that includes an isocyanate prepolymer can be supplemented with additional isocyanate. The additional isocyanate can be the same isocyanate used to make the isocyanate prepolymer, a different isocyanate, or a combination thereof. In one embodiment, a composition that includes a polyol and/or polyamine prepolymer can be supplemented with additional polyol and/or polyamine prepolymer. The additional polyol and/or polyamine prepolymer can be the same polyol and/or polyamine prepolymer used to make the polyol and/or polyamine prepolymer, a different polyol and/or polyamine prepolymer, or a combination thereof.

The prepolymer differs from the product of the one-shot technique because the prepolymer does not cure into a completely reacted product. In one embodiment, an isocyanate prepolymer has less than 20%, less than 14%, less than 11%, or less than 8.5% unreacted isocyanate groups. In one embodiment, an isocyanate prepolymer has greater than 0.1%, greater than 0.5%, greater than 1%, greater than 2.5%, greater than 5%, or greater than 7% unreacted isocyanate groups. In one embodiment, an isocyanate prepolymer has from 0.5% to 5%, from 2.5% to 8%, or from 5.0% to 8.0% unreacted isocyanate groups. In one embodiment, a polyol and/or polyamine prepolymer has less than 14%, less than 11%, or less than 8.5% unreacted alcohol and/or amine groups. In one embodiment, a polyol and/or polyamine prepolymer has greater 1%, greater than 2.5%, greater than 5%, or greater than 7% unreacted alcohol and/or amine groups.

The prepolymer technique also involves a second reaction between the prepolymer (e.g., the first reactive component) and a polyol and/or polyamine mixture (e.g., the second reactive component). The first and second reactive components are introduced into a mixing chamber for a period of time sufficient to form a partially reacted thermoset product and result in the predetermined layer resolution upon exiting the mixing chamber, and extruding the partially reacted thermoset product out of the mixing chamber through an extrusion nozzle and onto a substrate. The viscosities of the first and second reactive components are typically close enough that a mixing chamber with a static mixer results in sufficient mixing of the two reactive components. Examples of static mixers include 12-fold and 24-fold mixers, blade mixers, and helical mixers. For example, a static mixer can be used when the viscosity of the first reactive component and the viscosity of the second component are within a factor of no greater than 10, no greater than 6, or no greater than 3 of each other. In another embodiment, the viscosities of the two reactive components are different enough to require use of a mixing chamber with an agitator, such as a mechanical agitator or a high-pressure impingement mixer. Other non-static mixers include an emulsive mixer, a simple agitated chamber, or a dispersive mixer.

Optionally and preferably, the reaction to produce a thermoset product described herein includes other additives, including but not limited to, a catalyst, a chain extender, a curing agent, a surfactant, a pigment, a dye, a rheology modifier, and a filler such as an inorganic filler. Examples of inorganic fillers include, but are not limited to, silicon oxide, a ceramic pre-cursor, or glass. An additive can be present in the first or second reactive component, or can be separately added to the mixing chamber as the first and second reactive components are being added to the mixing chamber. One or more than one additive can be present (e.g., a catalyst and a chain extender), and more than one type of additive can be present (e.g., a reaction can include dyes, multiple catalysts, multiple chain extenders, rheology modifiers, etc.). In one embodiment, a rheology modifier can alter thixotropic characteristics of a partially reacted thermoset product, and in one embodiment, a rheology modifier does not alter thixotropic characteristics of a partially reacted thermoset product. In one embodiment, a partially reacted thermoset product is not thixotropic, e.g., the partially reacted thermoset product does not decrease in viscosity when exposed to a force such as shaking, agitation, shearing, and the like. In one embodiment, a 3D object described herein does not have a thixotropic characteristic.

A catalyst is a compound that increases the rate of a chemical reaction. In one embodiment, a catalyst does not undergo any permanent chemical change. In another embodiment, a catalyst increases the rate of a chemical reaction and reacts with one or more reactive component. For instance, a catalyst can include hydroxyl, amine, and/or isocyanate functionality.

Chain extenders include low molecular weight highly reactive diols and diamines. In some embodiments, they are designed to form hard segments of two or more urea/urethane linkages between isocyanates. Molecular weights can range from, for instance, 18 to 1,000, in some embodiments with primary hydroxyl or amine termination. Examples include water, butanediol, di-ethylene glycol, hexane diol, E-100, E-300.

In one embodiment, the two reactive components are designed to include fast reactants and corresponding catalysts so that upon mixing the resulting thermoset product quickly exceeds required characteristics (e.g., viscosity) for predetermined layer resolution, but also designed to include slow reactants (e.g., in one embodiment, some slower reacting isocyanate and/or polyol functionalities) and corresponding catalysts so that the mixture is not completely reacted (i.e., it is a partially reacted thermoset product, not a completely reacted thermoset) at the time that the next layer is applied, thus bringing strong adhesion between layers. In other embodiments, the two reactive components are designed to include fast reactants and corresponding catalysts, or slow reactants and corresponding catalysts. “Fast” reactants refers to reactive components that react quickly enough to increase viscosity immediately (e.g., within 1 second after mixing) and form a partially reacted thermoset product that maintains its layer resolution after deposition on a substrate or a previously deposited layer of thermoset product. “Slow” reactants refers to reactive components that can begin to react after it is deposited and result in the final completely reacted thermoset product. The relative reaction speeds of various reactive components that produce polymers (e.g., polyurethanes) are known to the skilled person. For instance, aliphatic isocyanates are typically slower than aromatic isocyanates, methylene diphenyl di-isocyanates (MDI) are generally faster than toluene di-isocyanates (TDI), and one isocyanate on isophorone diisocyanate (IPDI) is much slower than the other. Fast reacting components include chain extenders, including but not limited to di-amine, water, and compounds that include a primary hydroxyl reaction group.

Fast and slow reactants can be in the same reactive component or in different reactive components. When both fast and slow reactants are in the same reactive component, the reactive component can be one that includes an isocyanate or one that includes a polyol. In one embodiment, the reactive component containing a polyol contains a fast reactant, a slow reactant, and a polyol and/or polyamine prepolymer, and that other reactive component includes at least one type of monomeric isocyanate and an isocyanate prepolymer. In one embodiment, one or more fast reactants can make up from 1% to 20% (wt %) of a reactive component. In one embodiment, one or more slow reactants can make up from 50% to 99% (wt %) of a reactive component.

In one embodiment, temperature can also be used to alter characteristics (e.g., viscosity) of the partially reacted thermoset product as it exits the extrusion nozzle, or to speed the reaction upon contacting the substrate or a previously deposited layer of thermoset product. The operating temperature of the printing environment, e.g., the reactants, the mixing chamber, the nozzle, the substrate, and/or the air of the chamber in which an object is created, can be from 0° C. to 150° C. The skilled person will recognize suitable operating temperatures can vary depending upon the thermoset. For instance, some polyester polyols are solid at room temperature, thus higher operating temperatures can be useful when creating an object with a polyester polyol.

In the practice of this disclosure, a composition can be employed wherein the segment lengths can be systematically altered to provide a change in mechanical properties (e.g., from flexible to hard, from solid to foam, or a combination thereof) during the deposition. As used herein, “segment length” refers to the smallest molecular weights between the linkage points (urethane, urea, etc.). For instance, use of a specific polyol results in a segment length based on the presence of that polyol in the polymer.

In one embodiment of this disclosure, a foam is 3D printed by co-extruding first and second reactive components effective to form a thermoset product and produce a gas when they come into contact. For example, a reactive component can be used which contains isocyanates with a second reactive component containing a blowing agent. A blowing agent is a compound that is capable of producing a cellular structure in a partially reacted thermoset product. Examples of blowing agents include chemical blowing agents, such as water, and physical blowing agents, such as Freon and other chlorofluorocarbons, hydrochlorofluorocarbons, and alkanes.

In one embodiment, the additive is water. The use of water as an additive in the production of a urethane and/or urea-containing polymer thermoset product results in a polyurethane/polyurea foam.

With respect to foams, numerous applications are envisioned, including orthotics, prosthetics, footwear, grips, seals, gaskets, sound barriers, shock absorption, prosthetic joints, among many others. Products with varied foam properties can be particularly advantageous. For example, informed by pressure-mapping, mattresses can be fabricated to provide ideal support for an individual's weight distribution and preferred sleeping position. Vibration dampening foams can be designed with varied cellular structure and material elasticity to dampen a broad spectrum of vibrations with a minimum amount of material. Space-efficient seating can be built for furnishings or transportation. Energy absorbing safety helmets can be designed with a higher level of comfort and fit. Foam padding can be designed for medical applications (such as wheelchair seating) with conforming fit and reduced pressure points to reduce the incidence of pressure-induced skin ulcers. Areas with open-cell structures can be placed within a structure of closed-cell structures to preferentially channel the flow of air of liquids through the part.

While the following description is in the context of foams, the description applies to thermoset products, including urethane and/or urea-containing polymers in general, both non-foam and foam. Foams are available in a range of hardness and resiliencies. The urethane and/or urea-containing polymer is very durable, permitting the foam to be used repeatedly without a change in properties. This range of properties permits these materials to be used in clinical settings where rigid positioning is required or where pressure distribution is more desirable.

Foams of urethane and/or urea-containing polymers are the product of a reaction between two reactant components. The range of foam properties is achieved by altering the relative weights of formulation components in order to balance reaction speed, interfacial tension of the reacting mixture, and elasticity of the polymeric scaffold. In 3D printing, an extrusion nozzle deposits material, e.g., partially reacted thermoset product, on a substrate layer by layer, following a 3D computer model of the desired 3D object.

The novel foam precursor formulas described herein enable high resolution 3D deposition to form a custom 3D foam object. By partially advancing the reaction of the precursors, such as polyurethane precursors, and adjusting catalyst and surfactant levels, it is possible to deposit the partially reacted thermoset product while maintaining the desired predetermined part resolution and mechanical integrity of the foam.

The production of a foam of urethane and/or urea-containing polymers differs from the production of a non-foam urethane and/or urea-containing polymer by the inclusion of water. Foams of urethane and/or urea-containing polymer are formed by the simultaneous reaction of isocyanates with water to form urea linkages and produce gas, and the reaction of isocyanates with multifunctional high molecular weight alcohols to form a crosslinked elastomeric foam scaffold. The reaction chemistry is illustrated here.

### Urea/Gas Evolution Reaction

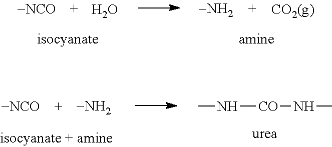

### Urethane/Polymerization Reaction

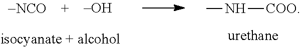

The gas evolution forms the porous structure of the foam, while surfactant addition stabilizes the foam structure to maintain a fine cellular structure. The concentrations of catalysts for each reaction, combined with the alcohol reactivity, balance the relative reaction rates so that sufficient polymer weight is built during the gas evolution to form a mechanically stable foam structure. In view of the teachings of the present disclosure, the skilled person can balance these variables, for instance by the inclusion of a blowing agent, to form a mechanically stable foam structure.

The conventional precursors used to make a foam of urethane and/or urea-containing polymers are low viscosity liquids. In typical foaming systems, the reacting liquid mixture is injected into a mold or foaming chamber, and the low viscosity of the liquid allows the mixture to flow and completely fill the mold while it expands. In 3D printing, the low viscosity and flow is undesirable; if the liquid spreads as it is deposited on the platform, the process produces a reacting puddle with little or no form.

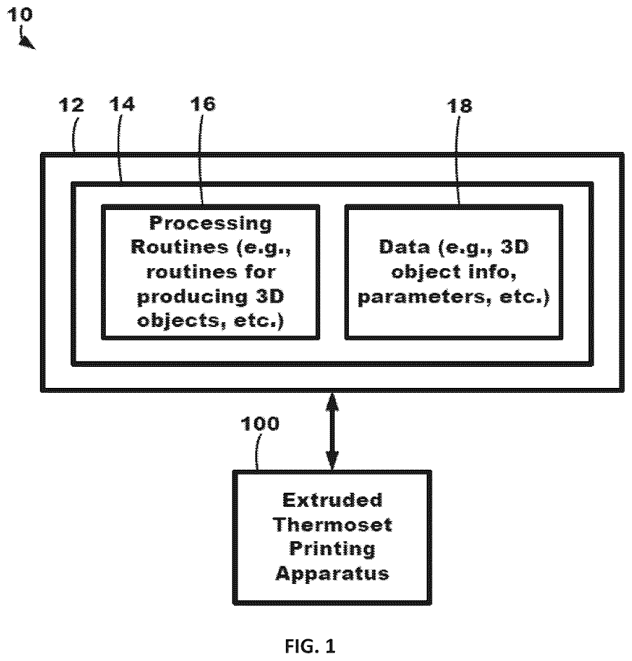

While the reacting mixture starts as a liquid, as the polymerization reaction advances, the viscosity of the mixture increases until it ultimately forms a solid, crosslinked network. Before the crosslinked network is formed, the reacting mixture passes through a viscosity that is high enough for high resolution printing. Therefore, the innovation includes precursors and their respective formulas such that the reacting mixture starts at a printable viscosity, and stays at that viscosity long enough to have sufficient working time (e.g., processing window) that the system is robust (FIG. 1). In one embodiment, an excess of isocyanates is pre-reacted with a polyol and/or polyamine mixture to achieve a printable starting viscosity. One of skill in the art can use techniques that are often used in the polyurethane and polyurea industry to reformulate the reactive components and control the speed of gas evolution and the stability of the foam structure.

In one embodiment, foams are formed by reacting simple monomers: a di-isocyanate, water, and multi-functional alcohol, also referred to herein as a polyol, or a multi-functional amine. The quantity of water in the formula affects the foam density, and also the strength of the foam scaffold. The molecular weight of the polyol and/or polyamine mixture determines the crosslink density of the foam scaffold and the resulting elasticity, resiliency, and hardness of the foam. A nearly stoichiometric quantity of di-isocyanate is used in order to fully react with the water and a polyol and/or polyamine mixture.

Prepolymer synthesis is a technique commonly used to alter the cure profile of a polyurethane or polyurea system. In prepolymer synthesis, a stoichiometric excess of di-isocyanate is reacted with a polyol and/or polyamine mixture. The resulting prepolymer has a higher molecular weight than the starting di-isocyanate, though molecules in the pre-polymer have isocyanate functionality and therefore are still reactive. Because of the higher molecular weight, hydrogen bonding, and/or urea linkages, the prepolymer also has a higher viscosity. This prepolymer can be subsequently reacted with a polyol and/or polyamine mixture and water to produce a foam with substantially the same foam scaffold composition that is achievable without prepolymer synthesis. However, viscosity growth profile is altered, typically starting higher, and increasing more slowly, and therefore the morphological features of the foam such as foam cell size and cell stability, can result in a foam with a very different appearance. Foams which start as prepolymers rather than their starting monomer components are common: household spray insulation foams, steering wheels, and microcellular shoe soles are examples.

For precursor design, isocyanate and polyol and/or polyamine mixture components which are commonly employed for cushioning or insulating foams can be used to systematically design prepolymers suitable for high resolution 3D printing. The curing profile of the system can be adjusted by tuning the ratios of the urea and urethane reaction catalysts in order to broaden the time window that the material is at a printable viscosity to, for instance, at least 30 seconds, and achieve a stable foam cellular structure. In one embodiment, a formulation maintains printable viscosity for at least 30 seconds, and a foam density of at most 0.5 g/cm³.

The composition is used in a 3D printer systems such as manufactured by Hyrel 3D (Norcross, GA), and in one embodiment the formula is chosen to form a printed foam object.

Once the formula is adequately mixed, the water reaction, which produces gas, is the fastest reaction and the liquid will start to froth and expand. Ultimately, the volume of the liquid increases, for instance 10 to 30 times, to form standard foam densities. If this expansion starts in the mixing zone of the extruder, the froth may emerge from the extruder at a fast, difficult-to-control rate. In this case, the skilled person will recognize that a shorter mixing zone can be used, or a narrower extrusion tip used to provide additional back pressure, therefore keeping the gas dissolved. Once the froth is deposited on the platform, the liquid will continue to expand. The skilled person will recognize that expansion takes place during the time required to print a single layer, and will adapt the robot controls to accommodate printing at the corresponding higher point.

Support foams are not a single density, hardness, or resilience, but can span a wide range of performance. This disclosure extends the foam property range of the formula and foam that was developed. Foam density and hardness are interrelated: low density foams are often softer foams. A range of foam density and hardness can be achieved first by varying the level of blowing agent such as water in the formulation and by adjusting the extent of excess isocyanate in the formula. Increasing the degree of functionality of the components of the polyol and/or polyamine mixture (e.g., incorporating some 4- or 6-functional polyols) increases hardness, and also increases the viscosity growth rate during cure. Foam resilience can be altered by varying the polyols and/or polyamines incorporated in the formula. Memory foams can be achieved by reducing the molecular weight of the polyols and polyamines; high resiliency can be achieved by incorporating graft polyols. In one embodiment, the foam density range is less than 0.3 g/cm3, ranging from 30-50 ILFD hardness, and resilience ranging from 10 to 50%. Foam properties also include open cell content and closed cell content. Open cell foams are defined as cellular structures built from struts, with windows in the cell walls which can permit flow of air or liquid between cells. Closed cells are advantageous for preventing air flow, such as in insulation applications.

The completely reacted thermoset product of a 3D object produced using the methods described herein has several characteristics, including, but not limited to hardness, resilience, strength, elasticity, density, durability, abrasion resistance, and flexibility.

Hardness refers to the amount of pressure that needs to be applied to deform the completely reacted thermoset product a certain distance. In one embodiment, a completely reacted thermoset product has a Shore A hardness from 20 to 120. For instance, the hardness can have a minimal Shore A value of at least 20, at least 30, at least 40, at least 50, at least 60, at least 70, at least 80, at least 90, at least 100, at least 110, or at least 120, and a maximum Shore A value of no greater than 120, no greater than 110, no greater than 100, no greater than 90, no greater than 80, no greater than 70, no greater than 60, no greater than 50, no greater than 40, no greater than 30, or no greater than 20. In another embodiment, a completely reacted thermoset product has a Shore D hardness from 3- to 120. For instance, the hardness can have a minimal Shore D value of at least 30, at least 40, at least 50, or at least 60 and a maximum Shore D value of no greater than 120, no greater than 110, no greater than 90, no greater than 80, or no greater than 70. Hardness is measured using a durometer, such as an ASTM D2240 durometer. While the hardness of non-foams can be measured using the Shore hardness scale, foams are typically too soft for the Shore hardness scale. Units of hardness for foams are Indentation Force Deflection (IFD), and the standard is set out by the Polyurethane Foam Association (Joint Industry Foam Standards and Guidelines, Section 4.0, available on the world wide web at www.pfa.org/jifsg/jifsgs4.html), the amount of force, in pounds, required to indent a 50 sq in foot 25% of its thickness, referred to as 25% IFD. In one embodiment, a completely reacted foam thermoset product has a 25% IFD from at least 15 lbs., at least 20 lbs., at least 30 lbs., or at least 35 lbs., to no greater than 60 lbs., no greater than 50 lbs., or no greater than 40 lbs. More rigid foams can also be characterized by compression resistance of 10% deflection, as defined in ASTM D1621, or according to bending strength as defined in EN 12089. In one embodiment, a rigid foam has a compression resistance ranging from 25 to 200 kPa, or a bending strength between 150 kPa and 2000 kPa.

Density refers to the mass of a completely reacted thermoset product per unit volume. In one embodiment, density is the mass of a completely reacted product excluding any filler. In one embodiment, a completely reacted solid thermoset product has a density of at least 0.8 g/mL, or at least 0.9 g/ml, and no greater that 1.3 g/ml or no greater than 1 g/ml. In one embodiment, a completely reacted foam thermoset product has a density of at least 0.05 g/ml, at least 0.1 g/ml, at least 0.5 g/ml, or at least 0.75 g/ml, and no greater than 1 g/ml, or no greater than 0.9 g/ml. Density is found by measuring mass on a material that has a defined geometry and size.

Durability refers to the ability for a part to sustain repeated stresses without failing. Durability can be measured two ways. In one embodiment, a stress-strain test can be performed in accordance with ASTM D638. Briefly, the part can be pulled at a constant strain rate, and the stress at the point at which the part breaks entirely (i.e., one side of the part is detached from the other) is measured. This can be measured when the force is applied in the print direction and transverse to the print direction. If the stress at break is significantly lower in the print direction (less than 75%), then the part is significantly less durable than a part that is fabricated by another means (i.e. injection molded) would be. Using this test a completely reacted thermoset product described herein has a durability of stress at break in the print direction of at least 50%, at least 55%, at least 60%, at least 65%, at least 70%, at least 75%, at least 80%, or at least 85%. In another embodiment, flexural durability is measured in accordance with ASTM D813 or ASTM D430. Briefly, in this method the test specimen is pierced or cracked and then repeatedly bent or stretched. The test measures the increase in size in the hole or the number of cycles required to get to a certain crack size. In parts that are 3D printed, the durability of the part is analyzed when the deformation is in varied directions relative to the print direction. The durability of the part is determined by the weakest direction (i.e., the direction where failure occurred at the lowest number of repeated deformation). As a 3D printing methodology, this disclosure uses a new hardening mechanism as the part is formed: rather than relying on photo-curing of acrylates or cooling to harden, this disclosure carefully times the chemical cure rate of a thermoset. With respect to polyurethanes, polyureas, and polyurethane/polyureas, such a strategy takes full advantage of the mechanical strength of polyurethane thermoset elastomers, which can be superior to photo-cured acrylates or thermoplastic urethanes (TPUs). One innovation to be employed is the specific design and synthesis of urethane precursors, urea precursors, and urethane/urea precursors (prepolymers, such as isocyanate oligomers) and formulation ingredients such as chain extenders, curing agents, and catalysts, to meet the demands for print resolution and z-direction part strength in 3D printing. Durability of FFF fabrication methods are limited by the incorporation of voids between strands during the printing process, with porosity as high as 5-15% range. The methods described herein can facilitate the selection of printing parameters to attain lower porosities such as no greater than 1%.

In one embodiment, a multi-ingredient (e.g., a 3-ingredient, 4-ingredient, a 5-ingredient, 6-ingredient, 7-ingredient, or 8-ingredient) urethane elastomer system is used. For instance, 3 or more reactive components can be used to produce a partially reacted thermoset product. In one embodiment, the resulting 3D object can have one or more properties vary between different areas of the 3D object. In one embodiment, the urethane system can print parts that cure to have a Shore A hardness from 30 to 80. A significant advantage of this system over photo-cured urethane-acrylate or acrylate-rubber systems available on the market is the durability of the parts. Urethane systems are the material of choice for elastomers requiring toughness, abrasion resistance, and low hysteresis, particularly in automotive parts, shoe soles, and prosthetics. Mechanical durability is a property that is helpful to move 3D printing from the domain of prototype development to manufacturing of functional parts. Ratios of reactive components can be controlled to achieved desired stoichiometric ratios. Accordingly, software can be used that controls the relative ratios of reactive components to be utilized in order to achieve, for instance, desired cure profiles, material properties, desired resolution, and processing window.

In one embodiment, the technology used herein uses a 3D printer which handles delivery of reactive systems (e.g., a first reactive component and a second reactive component). The process of manufacturing the parts uses one or more of the initial viscosities of the reactive components, the viscosity of the mixture exiting the extrusion nozzle, cure rate profiles, and interlayer adhesion (e.g., cross-linking) to determine extrusion amounts, setting times before an additional layer is applied, and so on. Compared to thermoplastic FFF, this product demonstrates advantages with regards to durability, z-direction strength, and porosity.

In the practice of this disclosure, the reactive system has a cure profile that matches the capabilities of the specific printer employed as well as demands for part resolution. A printable partially reacted thermoset product will have value propositions (e.g., characteristics), such as interlayer adhesion and part durability, that will be inherent to the urethane.

A challenge frequently encountered in 3D printing is the adhesion of the printed layers. Interlayer adhesion of one layer with the next is useful in making an object with strength and integrity in the vertical direction. Interlayer adhesion with the foaming system described herein is significantly improved over the existing amorphous polymer systems, as the slow urethane reaction is responsible for adhesive properties in some of the strongest industrial glues. Because the lower layer is not completely cured when the next layer is deposited, reactive chemical functionalities will be available from the lower layer to react with the next layer, and form strong covalent bonds between the layers. In one embodiment, to achieve sufficient interlayer adhesion, the speed to print a single layer is increased, first by increasing the deposition rate, and next by reducing the part dimensions. In another embodiment, the urethane reaction is decreased by adapting the precursor formula by reducing the urethane reaction catalyst level, increasing the amount of components in a polyol and/or polyamine mixture with slower-reacting, secondary hydroxyl groups, or both. Interlayer adhesion is measured first by manipulation on the final cured object, and validated by multi-directional tensile testing to confirm that the vertical direction strength is at least 50% of the strength of the part in the other directions.

Thermoset compositions are chosen such that the reactive components have a viscosity after mixing to maintain part resolution and inhibit layer break-up, e.g., the process by which a liquid stream breaks into droplets. This process is governed by surface tension, and the methods described herein can prevent this phenomenon by slowing the process with a high viscosity, and then solidifying faster than the droplet formation process. The printer includes a mixing chamber or zone designed such that the reactive components are intimately mixed, and with a residence time and optional catalyst level such that the reaction mixture has the required viscosity upon exiting the mixing zone through an extrusion nozzle. The thermoset compositions are chosen such that resolution is achieved but also such that the reaction is not complete when the next layer is deposited, e.g., when the next layer is deposited on a partially reacted thermoset product. In addition, the cure rate of the partially reacted thermoset product is balanced so that it is slow enough that it doesn't clog in the mixer, fast enough that the viscosity is sufficient to inhibit free flow of the part and reduce resolution, and still slow enough in late cure that the next layer will bond. Thus, this disclosure includes balancing cure rate with flow rate and corresponding residence times in a mixer at the printhead. Likewise, in this disclosure the matching viscosities and compatibilities of the two reactive components that will be mixed by adjusting compositions, e.g., viscosities and/or compatibilities can be matched by, for instance, (i) adjusting a ratio of monomeric isocyanate:isocyanate prepolymer in one reactive component, and by adjusting a ratio of polyol and/or polyamine mixture:polyol and/or polyamine prepolymer in the other reactive component, or (ii) adjusting the initial viscosity/molecular weight of the prepolymer as synthesized to match viscosities. The mixing chamber can include static mixing, or mechanical agitation can be used if needed. Also, when materials from finite product set are blended, they can they be blended in such a way that does not sacrifice material durability or cure control.

It has been found that FFF part resolution and surface roughness of existing methods is directly related to the viscosity of the material when it is extruded. PLA, which is a favorite in 3D printing because of its high resolution, has very low viscosity and minimal nonlinear viscoelasticity and die swell. The low viscosity of the partially reacted thermoset product described herein permits the use of lower diameter nozzles. For a given pressure and die length, the volumetric flow rate varies as R⁴/η, where R is the nozzle radius and η is the viscosity of a simple fluid; significant drops in viscosity can therefore lead to drops in nozzle radius without sacrificing printing speeds.

The thermosets described herein can be cured at mild temperatures, and even room temperature, negating the need for careful thermal control. Thermosets are seldom cured at temperatures above 50° C. These mild temperatures not only enable broad material property versatility within the part and reduced printer cost and design, but can also allow the incorporation of more thermally sensitive components, such as electronics and sensors, during the printing of the part. Furthermore, a thermoset product, such as urethane materials, may be 3D printed upon other metal or plastic parts (including, but not limited to, 3D printed parts) at low temperatures, without inducing thermal warpage or degradation. Accordingly, a 3D object described herein can include more than one type of material. In some embodiments, such as embodiments that use a semi-crystalline polyol (e.g., a polyester polyol), the temperature of the mixing chamber can be elevated above the melting point of the semi-crystalline polyol and then extruded and deposited onto a substrate and exposed to a temperature below the melting point of the semi-crystalline polyol. The subsequent crystallization aids in maintaining the shape of the 3D object while other components of the thermoset cure.

Existing photo-cured acrylate printer systems, such as the 3DS ProJet and the Stratasys Polyjet printers, operate by depositing liquid droplets of acrylates which are subsequently cured by light. By varying the acrylate reactive group density within each droplet, the material properties can be varied at a pixel level. The application of a curing liquid enables strong interlayer adhesion, largely eliminating the strength anisotropy observed in FFF. A disadvantage of these systems is the inkjetting layer thickness and the requisite inkjet printer head size; these attributes limit the scalability and part size for the photo-cured systems. The technology described herein offers similar benefits as the photo-cured systems over FFF of amorphous polymers (strong interlayer adhesion and voxel-level control of material properties). Printing with the thermosets described herein offers enhanced part durability, reduced printer costs, and increased part size.

Prior to cure, and at room temperature, the methods described herein can result in partially reacted thermoset products having viscosities as low as 1000 cP, without die swell. With viscosities 100-10,000 times lower than the viscosities of typical amorphous polymers, the nozzle radius used in the methods described herein can decrease by a factor of 3 to 10, enabling significantly higher print resolution without changing print speed. Alternatively, ETP printing speed can increase several orders of magnitude without hurting part resolution. ETP printing speed may be slowed by other factors, such as hardening rates of the material and robot head speed, and the skilled person will recognize that these parameters can be controlled and engineered separately.

The shape and size of the tip of the nozzle is not intended to be limiting, because it is expected that nearly any size and shape can be used with the partially reacted thermoset product. The skilled person will recognize that as the size of the nozzle tip decreases, the viscosity of the partially reacted thermoset product being extruded should be increased to compensate for interfacial tension that can break up the strand as it exits the nozzle tip. The skilled person will also recognize that as the size of the nozzle tip increases, the viscosity of the partially reacted thermoset product being extruded should be increased to compensate for the weight of the strand being extruded. A larger strand has a greater tendency to spread.

In any section of the extrusion device where the two reactive components are mixed, clogging can occur. The inventor has observed clogging in two scenarios: 1) gradual buildup of cured material in the mixer due to a combination of insufficient flow rate, fast cure rate, and/or a large distribution of residence times in the mixer, and/or 2) viscosity mismatch and chemical incompatibility between the two components, leading to channeling flow of the low viscosity material past the high viscosity material in the mixer. Furthermore, when flow through the mixer is stopped or started, the mixer can be filled with a disproportionate amount of one component if the viscosities are not similar or controls are not instituted to control the flow of one component separate from the first. Accordingly, in one embodiment the reactive components that are combined to form a mixture have viscosities that are different from each other by no greater than a factor of 3. For instance, the reactive components have viscosities that differ by a ratio of 1 to no greater than 3 (e.g., 1:3), 1 to no greater than 2 (e.g., 1:2), or 1 to no greater than 1 (e.g., 1:1).

In certain embodiments, the three-dimensional (3D) object production system or the three-dimensional (3D) object production method includes a controller comprising one or more processors. In certain embodiments, the three-dimensional (3D) object production system or the three-dimensional (3D) object production method can be operably coupled to an extruded thermoset printing apparatus. In certain embodiments, the three-dimensional (3D) object production system or the three-dimensional (3D) object production method comprises at least one actuator operably coupled to the extrusion nozzle to move the extrusion nozzle when delivering thermoset product to form the 3D object.

In certain embodiments, the controller comprising one or more processors can provide instructions to the extruded thermoset printing apparatus. These instructions can modify the method for printing a 3D object. In certain embodiments, these instructions instruct at least one actuator operably coupled to the extrusion nozzle to move the extrusion nozzle when delivering thermoset product to form the 3D object.

In certain embodiments, the controller can adjust one or more parameters of the at least one actuator to produce the 3D object based on a reaction rate between a first reactive component and a second reactive component to provide the thermoset product. In certain embodiments, the controller can adjust one or more parameters of the at least one actuator to produce the 3D object based on a reaction rate between a first reactive component, a second reactive component, and a third reactive component to provide the thermoset product. In certain embodiments, the controller can adjust one or more parameters of the at least one actuator to produce the 3D object based on a reaction rate between a first reactive component, a second reactive component, and at least one additional reactive component (e.g., three, four, five, six, seven, eight, nine, or ten total reactive components) to provide the thermoset product.

Applicant has surprisingly discovered that adjusting one or more parameters of the at least one actuator to produce the 3D object based on a reaction rate between the reactive components can provide an unexpectedly superior 3D printed object as compared to methods in the art. In certain embodiments, the one or more parameters can comprise at least one of a time per layer of thermoset product, a flow rate of the thermoset product through the extrusion nozzle, a viscosity of the thermoset product through the extrusion nozzle, a cure acceleration of the thermoset product, a layer translation path, a layer pattern, a seam structure, movement speed, and corner speed.

In certain embodiments, a time per layer of the thermoset product can be adjusted to optimize the time between layers extruded by the extrusion nozzle. Depending on the properties of the reactive components and the geometry of the desired final 3D product, the time per layer adjustment can vary. As used herein, the term “time per layer of thermoset product” means the minimum amount of time which should elapse before a next layer can be deposited on top of it.

In certain embodiments, the minimum time per layer of thermoset product can be from about 10 seconds to several hours. In certain embodiments, the time per layer of thermoset product can be from about 30 seconds to about 30 minutes. In certain embodiments, the time per layer of thermoset product can be from about 60 seconds to about 20 minutes. In certain embodiments, the time per layer of thermoset product can be about 10 seconds, about 20 seconds, about 30 seconds, about 40 seconds, about 50 seconds, about 60 seconds, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, about 30 minutes, about 35 minutes, about 40 minutes, 50 minutes, 1 hour, 1.5 hours, 2 hours, or any ranges between the specified values. If an insufficient amount of time has elapsed between depositing a layer and subsequently depositing another layer, when the next layer is deposited, it can melt or flow into the prior layer. In certain embodiments, a layer has height x, and when the next layer is deposited, the height of the part can be 2x. If an insufficient amount of time has elapsed, after the next layer is deposited, the height can be less than 2x. In certain embodiments, if the height is within about 5% of 2x, the minimum time can be said to have elapsed

In certain embodiments, a flow rate of the thermoset product through the extrusion nozzle can be adjusted to optimize the flow rate through the extrusion nozzle. Depending on the properties of the reactive components and the geometry of the desired final 3D product, the flow rate adjustment can vary. As used herein, the term “flow rate through the extrusion nozzle” means a volumetric flow rate, or a volume of material in mm³ that is pushed through the nozzle in a second. The rate can vary depending on the tip diameter. In certain embodiments, the minimum rate can be set by the strength of the pump on the printer. In certain embodiments, the flow rate can controlled by setting the pump displacement.

In certain embodiments, the flow rate through the extrusion nozzle can be from about 0.01 mm³/s to about 1 mm³/s. In certain embodiments, the flow rate can be from about 0.05 mm³/s to about 0.75 mm³/s. In certain embodiments, the flow rate can be from about 0.1 mm³/s to about 0.5 mm³/s. In certain embodiments, the flow rate can be about 0.01 mm³/s, about 0.02 mm³/s, about 0.03 mm³/s, about 0.04 mm³/s, about 0.05 mm³/s, about 0.06 mm³/s, about 0.07 mm³/s, about 0.08 mm³/s, about 0.09 mm³/s, about 0.1 mm³/s, about 0.15 mm³/s, about 0.2 mm³/s, about 0.25 mm³/s, about 0.3 mm³/s, about 0.35 mm³/s, about 0.4 mm³/s, about 0.45 mm³/s, about 0.5 mm³/s, about 0.55 mm³/s, about 0.6 mm³/s, about 0.65 mm³/s, about 0.7 mm³/s, about 0.75 mm³/s, about 0.8 mm³/s, about 0.85 mm³/s, about 0.9 mm³/s, about 0.95 mm³/s, about 1 mm³/s, or any ranges between the specified values. In certain embodiments, the flow rate of the material, combined with the volume of the mixing chamber, can set the extent of reaction of the material at the time that it leaves the nozzle. For example, if the printer is printing at 0.1 mm³/s and the mixer has a volume of 2 mm³, then the reaction mixture can be, on average, about 20 seconds into its reaction. If the flow rate is decreased to 0.01 mm³/s, then the reaction mixture can be, on average, about 200 seconds into its reaction.

In one embodiment, the reactive components have a flow rate through the mixing chamber such that the flow rate of the partially reacted thermoset product is constant at constant pumping pressure and/or load for at least 10 minutes or at least 20 minutes. In one embodiment, the reactive components have a flow rate through the mixer such that the flow rate of the partially reacted thermoset product is reduced by no greater than 5% (at least 95% of initial flow rate), no greater than 10%, no greater than 15%, or no greater than 20% at constant pumping pressure and/or load for at least 10 minutes or at least 20 minutes. In one embodiment, the partially reacted thermoset product does not form clogs in the mixing chamber and/or the extrusion nozzle when flow stops for no greater than 5 seconds, no greater than 10 seconds, or no greater than 30 seconds. In one embodiment, the partially reacted thermoset product does not increase pressure and/or load present in the mixing chamber by more than 10%, more than 15%, more than 20%, or more than 25% from the starting pressure in no greater than 2 minutes, no greater than 5 minutes, no greater than 10 minutes, or no greater than 60 minutes. Maintaining a flow through the mixing chamber, an absence of clogs, or a minimal increase in pressure and/or load can occur when the amounts of first and second reactive components are constant or are changing.

As used herein a “processing window” refers to the range of flow rates for a partially reacted thermoset product through a mixing chamber and extrusion nozzle. The lowest flow rate of a processing window is the slowest flow rate that can be maintained that does not increase pressure and/or load present in the mixing chamber by more than 10%, more than 15%, more than 20%, or more than 25% from the starting pressure in no greater than 2 minutes, no greater than 5 minutes, no greater than 10 minutes, or no greater than 60 minutes. The highest flow rate of a processing window is the fastest flow rate that can be maintained without exceeding the pressure limitations of the printing system, e.g., limitations of the mixing chamber, the pumping system, etc. Printers equipped with capabilities to impart higher pressures to move the fluids will have larger processing windows. Similarly, partially reacted thermoset products that have a slow growth or plateau in viscosity will have a larger processing window. Large processing windows are advantageous for minimizing interruptions due to clogs, speeding print times, and allowing operation with a range of nozzle diameters and resolutions. In view of the teachings of the present disclosure, the skilled person can determine the processing window for a set of reactive components, and alter variables including the types and concentrations of chemicals in reactive components to achieve useful processing windows. In one embodiment, a useful processing window is one where the ratio of the highest flow rate to the lowest flow rate is at least 2, at least 10, at least 25, at least 50, at least 75, at least 100.

An advantage of the methods described herein is that flow rate through the nozzle can give a way to control resolution. With a shorter residence time, or faster flow rate, the partially cured thermoset product will typically have reduced resolution. It can be desirable to shorten overall printing times, and shorter overall printing times can be achieved by moving slowly in areas of the part requiring high resolution, but flowing more quickly in areas of the part that do not require high resolution, such as filling an outlined shape.

In certain embodiments, a viscosity of the thermoset product through the extrusion nozzle can be adjusted to optimize the viscosity of the thermoset product through the extrusion nozzle. Depending on the properties of the reactive components and the geometry of the desired final 3D product, the viscosity can vary. Viscosity increases as a function of molecular weight of a polymer. Viscosity also increases as a function of concentration of urethane and urea linkages in the material. Therefore, for a given A (isocyanate blend) and B (polyol blend), as they react, the viscosity will increase. For example, for a given A and B, if a mixture leaves the extrusion nozzle at 200 seconds, it can have a higher extent of reaction, higher density of urethane/urea groups, and higher molecular weight than if it leaves the extrusion nozzle at 20 seconds. In certain embodiments, as the time from mixing of reactive components to the time a mixture leaves an extrusion nozzle increases, the viscosity can increase.

In certain embodiments, a material with a higher extent of reaction can give a bead with a different aspect ratio (cross-sectional width over height) than one with a lower extent of reaction. In certain embodiments, the aspect ratio can be from about 1 to about 10. In certain embodiments, the aspect ratio can be from about 1 to about 5. In certain embodiments, the aspect ratio about 1, about 1.5, about 2, about 2.5, about 3, about 3.5, about 4, about 4.5, about 5, about 6, about 7, about 8, about 9, about 10, or any ranges between the specified values. In certain embodiments, the aspect ratio can be inversely proportional to the viscosity. For example, an aspect ratio of 1 will be for a higher viscosity bead than an aspect ratio of 5, which is for a lower viscosity bead.

Applicant has surprisingly found that controlling aspect ratio of the bead can provide for printing optimization and provide for a printed 3D object with desirable object resolution. In certain embodiments, the aspect ratio can be used to set the space filling attributes of a material. In certain embodiments, the aspect ratio is related to the extent of polymerization of a material and the viscosity of a material. For example, if an aspect ratio is 5, then the layer height is shorter, but the translation path of the printhead can travel with a greater distance between adjacent beads. Comparatively, if an aspect ratio is 1, then the translation path provides that adjacent beads be placed closer to produce a solid part. In certain embodiments, the flow rate through the printhead, which sets its viscosity and therefore bead aspect ratio, can be used to set resolution, as well as overall printing speed. At slower flow rates and low aspect ratios, the print resolution can be the bead width. At higher flow rates, the high aspect ratio allows a layer to be filled quickly with fewer adjacent beads. The resolution can be the wider bead width associated with the lower viscosity.

In certain embodiments, a controller can analyze aspect ratio and print a 3D object based on the aspect ratio of a bead. For example, the controller can instruct the 3D printer to print with a low aspect ratio/high viscosity bead for certain aspects of a 3D object and then the controller can instruct the 3D printer to print with a high aspect ratio/low viscosity bead for other aspects of a 3D object. This controlling of aspect ratio can provide a 3D object with high resolution, e.g., on the edges of a 3D object, and then use increased printing speeds to space fill aspects of a 3D object.

In certain embodiments, a cure acceleration of the thermoset product can be adjusted to optimize the cure acceleration of the thermoset product. Depending on the properties of the reactive components and the geometry of the desired final 3D product, the cure acceleration can vary. In certain embodiments, a cure acceleration can be achieved by increasing the extent of reaction at a given time. In certain embodiments, an accelerant can be a catalyst or a formula with reactants designed with higher reactivity.

In certain embodiments, a layer translation path can be adjusted to optimize the layer translational path of the extruded thermoset product. Depending on the properties of the reactive component and the geometry of the desired final 3D product, the layer translational path can vary. As used herein the term “layer translation path” means the path that is traversed by the printhead while depositing material in the layer. In certain embodiments, the path can be followed to deposit material in the areas that have been specified by the slicing application. In certain embodiments, the layer translational path can be chosen such that a minimum amount of time elapses before an adjacent bead is placed. In certain embodiments, this minimum amount of time can be from about 1 second to about 5 minutes. In certain embodiments, this minimum amount of time can be from about 5 seconds to about 1 minute. In certain embodiments, this minimum amount of time can be about 1 second, about 5 seconds, about 10 seconds, about 15 seconds, about 20 seconds, about 25 seconds, about 30 second, about 35 seconds, about 40 seconds, about 45 seconds, about 50 seconds, about 60 second, about 90 seconds, about 2 minutes, about 3 minutes, about 4 minutes, about 5 minutes, or any ranges between the specified values. If an insufficient amount of time has elapsed, the beads can combine and form a bead with a different aspect ratio than a single bead. In certain embodiments, the algorithm which constructs a translation path can control a layer translation path such that a bead deformation does not occur when beads are placed adjacent to one another.

In certain embodiments, a layer pattern can be adjusted to optimize the layer pattern of the extruded thermoset product. Depending on the properties of the reactive component and the geometry of the desired final 3D product, the layer pattern can vary. As used herein the term “layer pattern” means the pattern that is traversed by the printhead while depositing material in the layer. In certain embodiments, a layer pattern can be the systematic path that the printhead is directed to fill an area. In certain embodiments, a layer pattern can be to fill a circle with concentric circles from the outside in. In certain embodiments, a layer pattern can be a pattern where adjacent parallel lines are placed. In certain embodiments, the layer pattern can be chosen such that a minimum amount of time elapses before an adjacent bead is placed. In certain embodiments, this minimum amount of time can be from about 1 second to about 5 minutes. In certain embodiments, this minimum amount of time can be from about 5 seconds to about 1 minute. In certain embodiments, this minimum amount of time can be about 1 second, about 5 seconds, about 10 seconds, about 15 seconds, about 20 seconds, about 25 seconds, about 30 second, about 35 seconds, about 40 seconds, about 45 seconds, about 50 seconds, about 60 second, about 90 seconds, about 2 minutes, about 3 minutes, about 4 minutes, about 5 minutes, or any ranges between the specified values. If an insufficient amount of time has elapsed, the beads can combine and form a bead with a different aspect ratio than a single bead. In certain embodiments, the algorithm which constructs a fill pattern can control a layer pattern such that a bead deformation does not occur when beads are placed adjacent to one another.

A curing thermoset product described herein is deposited as a layer or strand when the diffusion rate of molecules from one layer into another layer is substantially higher, optionally including low molecular weight component curing agents having diffusion rates that are much faster. Furthermore, the density of reactive groups is typically 2-20% by weight, where the density of reactive groups is given as moles of isocyanate or moles of hydroxyl per unit volume as derived from measured NCO or hydroxyl content. % NCO is a standard measurement, and is wt.-% of NCO functionalities per weight of the formula. Not only is the diffusion rate high, but the opportunity to establish covalent bonds between the layers is substantial. This disclosure permits the flexibility to adjust the density of reaction groups, their reactivity, and their mobility so that strong interlayer adhesion can be achieved, approaching strengths comparable to bulk mechanical properties. Typically, a second layer is deposited on a first layer while the first layer is partially reacted, thereby increasing the interlayer adhesion between the two layers. In one embodiment, the time that can elapse between depositing each layer can be no greater than 0.5 minute, no greater than 1 minute, no greater than 1.5 minutes, no greater than 2 minutes, no greater than 5 minutes, or no greater than 10 minutes. Application of energy, such as heat, can simultaneously speed diffusion and reaction rates. Accordingly, in one embodiment the method includes application of spot or ambient heating at the top layer to simultaneously promote bonding between layers and speed the hardening process.

While not wishing to be bound by theory, it is further postulated that amorphous thermoplastic FFF interfacial strength of existing technologies is hindered by the incorporation of small voids or pores between strands, typically from 45 to 15% (Paul—“Eliminating Voids in FDM Processed Polyphenylsulfone, Polycarbonate, and ULTEM 9085 by Hot Isostatic Pressing”, Mary Elizabeth Parker, Research report 2009, South Dakota School of Mines and Technology). These voids exist because the material viscosity is too high to flow and fill the gaps between strands, and leads to mechanical weakness in the printed parts. The partially reacted thermoset product described herein can have a viscosity that is several orders of magnitude lower than the amorphous polymer of existing FFF methods, and therefore can easily flow the short distance required to fill voids between strands and eliminate gaps.

In one embodiment of the reactive system described herein, the part hardness is a kinetic function of the extent of cure. The initial curing component (e.g., the partially reacted thermoset product) is very low viscosity, and the hardness develops as the curing reaction continues. Thus, for a large part, the portions of the part that are printed first are the stiffest, and thus can support weight, while the fresh layers are still soft and able to cure and adhere to subsequent layers. Furthermore, the rate of cure can be adjusted significantly by adjusting the formula reactivity (e.g., the density of reactive groups) and the catalyst levels in order to accommodate larger part designs and prints. The thermoset 3D print system described herein therefore de-couples part size and warpage from the requirements for strong interlayer adhesion.

In certain embodiments, a seam structure can be adjusted to optimize the seam structure of the extruded thermoset product. Depending on the properties of the reactive components and the geometry of the desired final 3D product, the seam structure can vary. As used herein, the term “seam structure” means the vertical line formed when each layer begins printing at the same X, Y point.

In certain embodiments, a movement speed can be adjusted to optimize the movement speed of the extruded thermoset product and of the extrusion nozzle. Depending on the properties of the reactive components and the geometry of the desired final 3D product, the movement speed can vary. As used herein, the term “movement speed” means the linear speed traversed by a printhead. In certain embodiments, the movement speed can be from about 1 mm/s to about 50 mm/s. In certain embodiments, the movement speed can be from about 2 mm/s to about 25 mm/s. In certain embodiments, the movement speed can be about 1 mm/s, about 2 mm/s, about 3 mm/s, about 4 mm/s, about 5 mm/s, about 6 mm/s, about 7 mm/s, about 8 mm/s, about 9 mm/s, about 10 mm/s, about 11 mm/s, about 12 mm/s, about 13 mm/s, about 14 mm/s, about 15 mm/s, about 16 mm/s, about 17 mm/s, about 18 mm/s, about 19 mm/s, about 20 mm/s, about 21 mm/s, about 22 mm/s, about 23 mm/s, about 24 mm/s, about 25 mm/s, or any ranges between the specified values.

In certain embodiments, a corner speed can be adjusted to optimize the corner speed of the extruded thermoset product and of the extrusion nozzle. Depending on the properties of the reactive components and the geometry of the desired final 3D product, the corner speed can vary. As used herein the term “corner speed” can mean a minimum turning radius for a given linear speed. As each curve in a 3D printed bead is made up from several linear segments this ability to change direction can be expresses as a maximum angular velocity where;

$$maximum angular velocity ω = \frac{d θ}{dt}$$

and where θ is the corner angle
   and
maximum linear velocity v=ωr
where r is the radius of the corner

In certain embodiments, the controller can adjust one or both of the amount and flow rate of one or more of first, second, and third reactive components to provide a thermoset product for the first area of the 3D object design to provide the physical property of the first area that is different than the same physical property of the second area. In certain embodiments, the physical property can be one or more of flexibility, color, optical refractive index, hardness, porosity, and density.

In certain embodiments, the controller can be configured to execute or the method further comprises adjusting one or both of an amount and a flow rate of a gas-generation source for use with one or more of a first, second, and third reactive components.

In certain embodiments, the controller can be configured to execute or the method further comprises controlling a distance between the extrusion nozzle and the 3D object. Applicant has surprisingly discovered that controlling a distance between the extrusion nozzle and the 3D object can provide an unexpectedly superior 3D printed object as compared to methods in the art.

This disclosure further encompasses extruder designs wherein the mixing zone is easily replaced. The disclosure further encompasses cleaning methods wherein any clogs of crosslinked material are removed.

In certain embodiments, the controller can be configured to detect an obstruction within the extruded thermoset printing apparatus. In certain embodiments, the controller can be configured to remove an obstruction within the extruded thermoset printing apparatus. During 3D printing, reactive components can obstruct, clog, block, or fill a part of the extruded thermoset printing apparatus. By using the controller to detect and remove an obstruction, a uniform and accurate 3D printed object can be printed. In certain embodiments, the obstruction can be inside the extruded thermoset printing apparatus (e.g., on the inside of the nozzle). In certain embodiments, the obstruction can be on the exterior of the extruded thermoset printing apparatus (e.g., on the outside of the nozzle or on the tip of the nozzle). In certain embodiments, the obstruction is removed automatically, e.g., by purging to a disposal cup. In certain embodiments, the obstruction is removed manually, e.g., by manually wiping the nozzle.

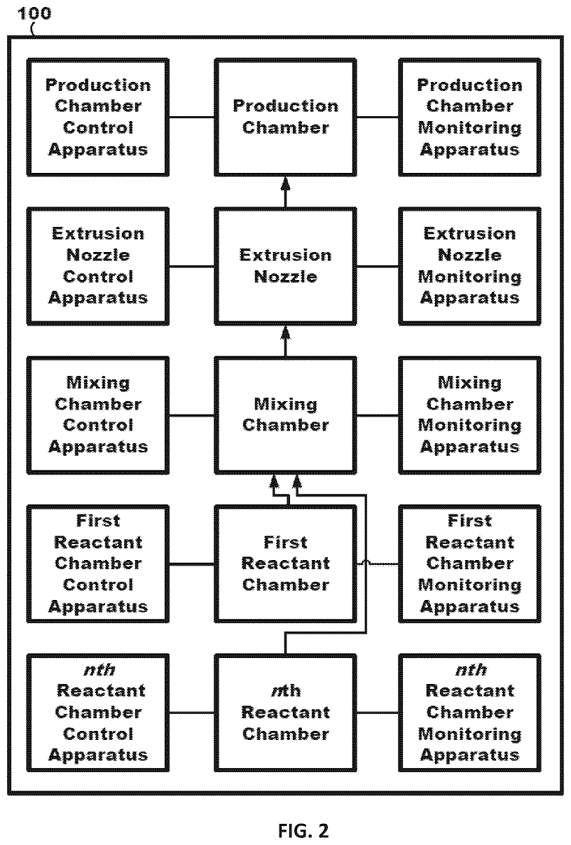

Exemplary systems, apparatus, devices, methods, and processes shall be described with reference to FIGS. 1 and 2. It will be apparent to one skilled in the art that elements or processes from one embodiment may be used in combination with elements or processes of the other embodiments, and that the possible embodiments of such systems, apparatus, devices, methods, and processes using combinations of features set forth herein is not limited to the specific embodiments shown in the figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

The exemplary 3D object production system 10 used to execute, or perform, the exemplary methods and/or processes described herein is further depicted diagrammatically in FIG. 1. As shown, the exemplary system 10 may include computing apparatus 12. The computing apparatus 12 may be configured to receive input and transmit output to extruded thermoset printing apparatus 100 such that, for example, the computing apparatus 12 may use, or work with, the extruded thermoset printing apparatus 100 to produce a 3D object.

Further, the computing apparatus 12 may include data storage 14. Data storage 14 may allow for access to processing programs or routines 16 and one or more other types of data 18 (e.g., 3D object designs, computer-aided design (CAD) files, sensor data, material properties, parameters, metrics, variables, etc.) that may be employed to perform, or carry out, exemplary methods and/or processes for use in performing control of production of 3D objects and/or translation of 3D designs into one or more printing processes to produce 3D objects. The computing apparatus 12 may be described as being operatively coupled to the extruded thermoset printing apparatus 100 to, e.g., transmit data to and from the extruded thermoset printing apparatus 100. For example, the computing apparatus 12 may be electrically coupled to the extruded thermoset printing apparatus 100 using, e.g., analog electrical connections, digital electrical connections, wireless connections, bus-based connections, etc.

The processing programs or routines 16 may include programs or routines for performing computational mathematics, a slicing application, CAD processes, 3D design translation algorithms and processes, spatial algorithms, process automation algorithms, matrix mathematics, standardization algorithms, comparison algorithms, feedback control loops, or any other processing required to implement one or more exemplary methods and/or processes described herein. Data 18 may include, for example, 3D object design data, 3D object information, parameters, 3D printing parameters, material properties, sensor data, variables, results from one or more processing programs or routines employed according to the disclosure herein, or any other data that may be necessary for carrying out the one and/or more processes or methods described herein.

In one or more embodiments, the system 10 may be implemented using one or more computer programs executed on programmable computers, such as computers that include, for example, processing capabilities, data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or methods as described herein or as would be applied in a known fashion.

The programs used to implement the methods and/or processes described herein may be provided using any programmable language, or code, e.g., a high-level procedural and/or object orientated programming language or code that is suitable for communicating with a computer system. Any such programs may, for example, be stored on any suitable device, e.g., a storage media, that is readable by a general or special purpose program running on a computer system (e.g., including processing apparatus) for configuring and operating the computer system when the suitable device is read for performing the procedures described herein. In other words, at least in one embodiment, the system 10 may be implemented using a computer readable storage medium, configured with a computer program, where the storage medium so configured causes the computer to operate in a specific and predefined manner to perform functions described herein. Further, in at least one embodiment, the system 10 may be described as being implemented by logic (e.g., object code) encoded in one or more non-transitory media that includes code for execution and, when executed by a processor, is operable to perform operations such as the methods, processes, and/or functionality described herein.

The computing apparatus 12 may be, for example, any fixed or mobile computer system (e.g., a controller, a microcontroller, a personal computer, minicomputer, etc.). The exact configuration of the computing apparatus 12 is not limiting, and essentially any device capable of providing suitable computing capabilities and control capabilities may be used as described herein, a digital file may be any medium (e.g., volatile or non-volatile memory, a CD-ROM, magnetic recordable tape, etc.) containing digital bits (e.g., encoded in binary, etc.) that may be readable and/or writeable by computing apparatus 12 described herein. Also, as described herein, a file in user-readable format may be any representation of data (e.g., ASCII text, binary numbers, hexadecimal numbers, decimal numbers, graphically, etc.) presentable on any medium (e.g., paper, a display, etc.) readable and/or understandable by an operator.

In view of the above, it will be readily apparent that the functionality as described in one or more embodiments according to the present disclosure may be implemented in any manner as would be known to one skilled in the art. As such, the computer language, the computer system, or any other software/hardware which is to be used to implement the processes described herein shall not be limiting on the scope of the systems, processes or programs (e.g., the functionality provided by such systems, processes or programs) described herein.

The methods and/or logic described in this disclosure, including those attributed to the systems, or various constituent components, may be implemented, at least in part, in hardware, software, firmware, or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems, devices and methods described in this disclosure may be embodied as instructions and/or logic on a computer-readable medium such as RAM, ROM, NVRAM, EEPROM, FLASH memory, magnetic data storage media, optical data storage media, or the like. The instructions and/or logic may be executed by one or more processors to support one or more aspects of the functionality described in this disclosure.

The extruded thermoset printing apparatus 100 may include any one or more devices, mechanisms, and structures so as to be capable of performing the 3D object generation or printing as described herein. Generally, as shown in FIG. 2, the extruded thermoset printing apparatus 100 may include at least a first reactant chamber for holding, or contain, a first reactant and one or more additional reactant chambers, or nth reactant chamber, for holding, or contain, additional or nth reactants. The reacting chambers may be operably coupled to a mixing chamber such that the reactants may be mixed to produce, or provide, thermoset product as described herein. The mixing chamber may be operably coupled to the extrusion nozzle, which can deliver the thermoset product to a production chamber where the 3D object is being printed or formed.

Each of the portions or items of the system 100, some of which are depicted in FIG. 2, may have corresponding monitoring apparatus operably coupled thereto. For example, the apparatus 100 may include first reactant chamber monitoring apparatus operably coupled to the first reactant chamber to monitor one or more parameters and/or variables related thereto, and nth reactant chamber monitoring apparatus operably coupled to the nth reactant chamber to monitor one or more parameters and/or variables related thereto. Further, the apparatus 100 may include mixing chamber monitoring apparatus, extrusion nozzle monitoring apparatus, and production monitoring apparatus operably coupled to the mixing chamber, extrusion nozzle, and production chamber, respectively, to monitor one or more parameters and/or variables related thereto.

Each of the portions or items of the system 100, some of which are depicted in FIG. 2, may have corresponding control apparatus operably coupled thereto. For example, the apparatus 100 may include first reactant chamber control apparatus operably coupled to the first reactant chamber to control, modify, or adjust one or more settings, parameters, and/or processes related thereto, and nth reactant chamber control apparatus operably coupled to the nth reactant chamber to control one or more settings, parameters, and/or processes related thereto. Further, the apparatus 100 may include mixing chamber control apparatus, extrusion nozzle control apparatus, and production control apparatus operably coupled to the mixing chamber, extrusion nozzle, and production chamber, respectively, to control one or more settings, parameters, and/or processes related thereto.

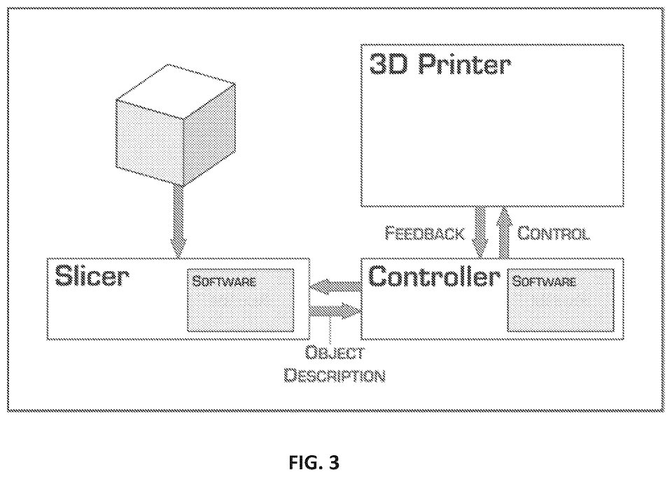

FIG. 3 is a block diagram of an exemplary 3D object production system. In FIG. 3, the slicing application software sends an object description to a controller. The controller sends control instructions to a 3D printer to print a 3D object. The 3D printer sends feedback to the controller, which then sends feedback to the slicing application.

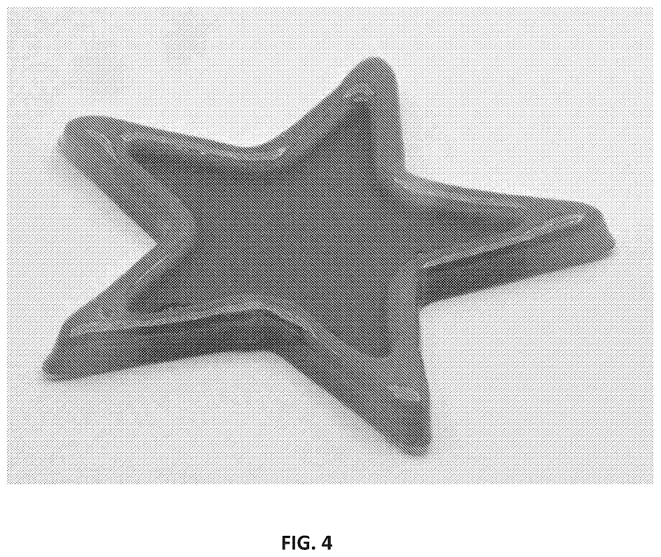

FIG. 4 is a printed 3D object having two different thermoset components. The 3D object has the shape of a star. The interior darker colored portion of the star is composed of a hard thermoset material. The exterior lighter colored portion of the star is composed of a soft thermoset material.

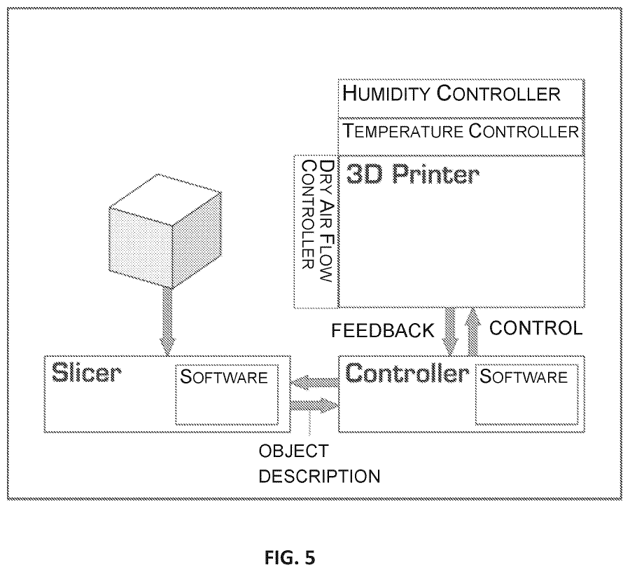

FIG. 5 is a block diagram of an exemplary 3D object production system. In FIG. 5, the slicing application software sends an object description to a controller. The controller sends control instructions to a 3D printer to print a 3D object. The 3D printer sends feedback to the controller, which then sends feedback to the slicing application. The 3D printer contains controllers for monitoring and controlling humidity, temperature, and dry air flow.

Further modifications and alternative embodiments of this disclosure will be apparent to those skilled in the art in view of this description. It will be recognized, therefore, that the present disclosure is not limited by these example arrangements. Accordingly, this description is to be construed as illustrative only and is for the purpose of teaching those skilled in the art the manner of carrying out the disclosure. It is to be understood that the forms of the disclosure herein shown and described are to be taken as the presently preferred embodiments. Various changes may be made in the implementations and architectures. For example, equivalent elements may be substituted for those illustrated and described herein, and certain features of the disclosure may be utilized independently of the use of other features, all as would be apparent to one skilled in the art after having the benefit of this description of the disclosure.

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the apparatus and methods described herein. Various modifications of the illustrative embodiments, as well as additional embodiments of the disclosure, will be apparent upon reference to this description.

### EXEMPLARY EMBODIMENTS

Embodiment 1. A three-dimensional (3D) object production system comprising:
extruded thermoset printing apparatus comprising:
   an extrusion nozzle to deliver a thermoset product from a to form a 3D object,
   a mixing chamber to receive and mix at least a first reactive component, a second reactive component, and a third reactive component to provide the thermoset product, and
   metering apparatus to control at least an amount and a flow rate of the first reactive component, the second reactive component, and the third reactive component into the mixing chamber; and
   a controller comprising one or more processors and operably coupled to the extruded thermoset printing apparatus, wherein the controller is configured to:
      receive a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area, and
      produce the 3D object using the extruded thermoset printing apparatus based on the 3D object design by adjusting one or both of the amount and flow rate of one or more of the first, second, and third reactive components to provide the thermoset product for the first area of the 3D object design to provide the physical property of the first area that is different than the same physical property of the second area.

Embodiment 2. A three-dimensional (3D) object production method comprising:
providing extruded thermoset printing apparatus comprising:
   an extrusion nozzle to deliver a thermoset product from a to form a 3D object,
   a mixing chamber to receive and mix at least a first reactive component, a second reactive component, and a third reactive component to provide the thermoset product, and
   metering apparatus to control at least an amount and a flow rate of the first reactive component, the second reactive component, and the third reactive component into the mixing chamber;
receiving a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area; and
producing the 3D object using the extruded thermoset printing apparatus based on the 3D object design by adjusting one or both of the amount and flow rate of one or more of the first, second, and third reactive components to provide the thermoset product for the first area of the 3D object design to provide the physical property of the first area that is different than the same physical property of the second area.

Embodiment 3. A three-dimensional (3D) object production system comprising:
a controller comprising one or more processors and configured to:
   receive a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area, and
   generate one more extruded thermoset printing processes to produce the 3D object based on the 3D object design by adjusting one or both of the amount and flow rate of one or more of first, second, and third reactive components to provide a thermoset product for the first area of the 3D object design to provide the physical property of the first area that is different than the same physical property of the second area.

Embodiment 4. A three-dimensional (3D) object production method comprising:
receiving a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area; and
generating one more extruded thermoset printing processes to produce the 3D object based on the 3D object design by adjusting one or both of the amount and flow rate of one or more of first, second, and third reactive components to provide a thermoset product for the first area of the 3D object design to provide the physical property of the first area that is different than the same physical property of the second area.

Embodiment 5. The systems or methods as set forth in any one of Embodiments 1 to 4, wherein the physical property is flexibility.

Embodiment 6. The systems or methods as set forth in any one of Embodiments 1 to 4, wherein the physical property is color.

Embodiment 7. The systems or methods as set forth in any one of Embodiments 1 to 4, wherein the physical property is optical refractive index.

Embodiment 8. The systems or methods as set forth in any one of Embodiments 1 to 4, wherein the physical property is one of hardness, porosity, and density.

Embodiment 9. The systems or methods as set forth in any one of Embodiments 1 to 8, wherein the controller is further configured to execute or the method further comprises: adjusting one or both of an amount and a flow rate of a gas-generation source for use with one or more of the first, second, and third reactive components to provide the thermoset product for the first area of the 3D object design to provide the physical property of the first area that is different than the same physical property of the second area.

Embodiment 10. The systems or methods of Embodiment 9, wherein the controller is further configured to execute or the method further comprises: controlling a distance between the extrusion nozzle and the 3D object based on a foaming rate determined by the amount and flow rate of the gas-generation source.

Embodiment 11. The systems or methods as set forth in any one of Embodiments 1-10, wherein the thermoset product is partially-reacted thermoset product.

Embodiment 12. A three-dimensional (3D) object production system comprising:
extruded thermoset printing apparatus comprising:
an extrusion nozzle to deliver a thermoset product to form a 3D object, and
a mixing chamber to receive and mix at least a first reactive component and a second reactive component to provide the thermoset product; and
a controller comprising one or more processors and operably coupled to the extruded thermoset printing apparatus, wherein the controller is configured to:
   detect an obstruction within the extruded thermoset printing apparatus,
   remove the obstruction within the extruded printing apparatus, and
   produce a 3D object based on a 3D object design using thermoset product delivered by the extruded thermoset printing apparatus.

Embodiment 13. A three-dimensional (3D) object production method comprising:
providing extruded thermoset printing apparatus comprising:
   an extrusion nozzle to deliver a thermoset product to form a 3D object, and
   a mixing chamber to receive and mix at least a first reactive component and a second reactive component to provide the thermoset product;
detecting an obstruction within the extruded thermoset printing apparatus;
removing the obstruction within the extruded thermoset printing apparatus; and
producing a 3D object based on a 3D object design using thermoset product delivered by the extruded thermoset printing apparatus.

Embodiment 14. The system or method of Embodiment 12 or 13, wherein detecting an obstruction within the extruded thermoset printing apparatus comprises analyzing one or more properties of the extruded thermoset printing apparatus to detect the obstruction.

Embodiment 15. The system or method of Embodiment 14, wherein the extruded thermoset printing apparatus further comprises one or more pumps to at least deliver each of the first reactive component and a second reactive component to the mixing chamber, wherein the one or more properties of the extruded thermoset printing apparatus comprises torque of the one or more pumps.

Embodiment 16. The systems or methods as set forth in any one of Embodiments 12 to 15, wherein the extruded thermoset printing apparatus further comprises one or more flow meters to determine one or more of:
a first flow rate of the first reactive component to the mixing chamber,
a second flow rate of the second reactive component to the mixing chamber, and
an extrusion flow rate of the thermoset product from the extrusion nozzle, wherein the one or more properties of the extruded thermoset printing apparatus comprises one or more of the first flow rate, the second flow rate, and the extrusion flow rate.

Embodiment 17. The systems or methods as set forth in any one of Embodiments 12 to 16, wherein the extruded thermoset printing apparatus further comprises one or more pressure sensors to determine one or more of:
a mixing chamber pressure within the mixing chamber, and
an extrusion pressure within the extrusion nozzle, wherein the one or more properties of the extruded thermoset printing apparatus comprises one or more of the mixing chamber pressure and the extrusion pressure.

Embodiment 18. The systems or methods as set forth in any one of Embodiments 12 to 17, wherein controller is further configured to execute or the method further comprises:
initiate a cleaning event in response to detection of an obstruction within the extruded thermoset printing apparatus.

Embodiment 19. The systems or methods of Embodiment 18, wherein the cleaning event comprises one or more of a cleaning notification to notify the user of the obstruction and cleaning processes to clear the obstruction.

Embodiment 20. A three-dimensional (3D) object production system comprising:
extruded thermoset printing apparatus comprising:
   an extrusion nozzle to deliver a thermoset product to form a 3D object, and
   a mixing chamber to receive and mix at least a first reactive component and a second reactive component to provide the thermoset product; and
a controller comprising one or more processors and operably coupled to the extruded thermoset printing apparatus, wherein the controller is configured to:
   produce a 3D object based on a 3D object design using thermoset product delivered by the extruded thermoset printing apparatus, and
   detect one or more mixing properties based on the thermoset product as the thermoset product is delivered by the extruded thermoset printing apparatus.

Embodiment 21. A three-dimensional (3D) object production method comprising:
providing extruded thermoset printing apparatus comprising:
   an extrusion nozzle to deliver a thermoset product to form a 3D object, and
   a mixing chamber to receive and mix at least a first reactive component and a second reactive component to provide the thermoset product;
producing a 3D object based on a 3D object design using thermoset product delivered by the extruded thermoset printing apparatus; and
detecting one or more mixing properties based on the thermoset product as the thermoset product is delivered by the extruded thermoset printing apparatus.

Embodiment 22. The system or method as set forth in Embodiment 20 or 21, wherein the extruded thermoset printing apparatus further comprises a color detector to detect a color of the thermoset product as the thermoset product is delivered by the extruded thermoset printing apparatus, wherein the one or more mixing properties comprises color detected by the color detector.

Embodiment 23. The system or method of Embodiment 22, wherein the color detector comprises one or more of a photodetector, a photoresistor, a photodiode, and a phototransistor.

Embodiment 24. The systems or methods as set forth in any one of Embodiments 20 to 23, wherein the extruded thermoset printing apparatus further comprises a chemical property detector to detect one or more chemical properties of the thermoset product as the thermoset product is delivered by the extruded thermoset printing apparatus, wherein the one or more mixing properties comprises the one or more chemical properties detected by the chemical property detector.

Embodiment 25. The systems or methods of Embodiment 24, wherein the one or more chemical properties comprise at least one of urethane content, urea content, isocyanate content, and aromatic content.

Embodiment 26. The systems or methods as set forth in any one of Embodiments 20 to 25, wherein the controller is further configured to execute or the method further comprises:
determining whether quality of the thermoset product is acceptable based on the detected one or more mixing properties; and
initiating a quality control event in response to determination that quality of the thermoset product is not acceptable.

Embodiment 27. The systems or methods of Embodiment 26, wherein the quality control event comprises one or more of a quality control notification to notify the user of the unacceptability of the thermoset product, a delay process to allow for the quality of thermoset product to improve, and a purge process to purge the unacceptable thermoset product.

Embodiment 28. A three-dimensional (3D) object production system comprising:
extruded thermoset printing apparatus comprising:
   an extrusion nozzle to deliver a thermoset product to form a 3D object,
   a mixing chamber to receive and mix at least a first reactive component and a second reactive component to provide the thermoset product, and
   metering apparatus to control at least an amount and a flow rate of the first reactive component and the second reactive component into the mixing chamber; and
   a controller comprising one or more processors and operably coupled to the extruded thermoset printing apparatus, wherein the controller is configured to:
      produce a 3D object based on a 3D object design using thermoset product delivered by the extruded thermoset printing apparatus, and
      adjust flow of one or more of the first and second reactive components using the metering apparatus based on one or more flow properties of the thermoset product.

Embodiment 29. A three-dimensional (3D) object production method comprising:
providing extruded thermoset printing apparatus comprising:
   an extrusion nozzle to deliver a thermoset product to form a 3D object,
   a mixing chamber to receive and mix at least a first reactive component and a second reactive component to provide the thermoset product, and
   metering apparatus to control at least an amount and a flow rate of the first reactive component and the second reactive component into the mixing chamber;
producing a 3D object based on a 3D object design using thermoset product delivered by the extruded thermoset printing apparatus; and
adjusting flow of one or more of the first and second reactive components using the metering apparatus based on one or more flow properties of the thermoset product.

Embodiment 30. The system or method as set forth in Embodiment 28 or 29, wherein the extruded thermoset printing apparatus further comprises one or more flow detectors to monitor a flow rate of each of the first and second reactive components into the mixing chamber, wherein the one or more flow properties comprises the flow rate of the first reactive component into the mixing chamber and the flow rate of the second reactive component into the mixing chamber.

Embodiment 31. The systems or methods as set forth in any one of Embodiments 28 to 30, wherein the extruded thermoset printing apparatus further comprises one or more pressure detectors to monitor a pressure of each of the first and second reactive components prior to entering the mixing chamber, wherein the one or more flow properties comprises the pressure of the first reactive component and the pressure of the second reactive component.

Embodiment 32. The systems or methods as set forth in any one of claims 28-31, wherein producing a 3D object based on the 3D object design using thermoset product delivered by the extruded thermoset printing apparatus comprises calculating one or more flow properties of the thermoset product to produce the 3D object, wherein adjusting flow of one or more of the first and second reactive components using the metering apparatus based on one or more flow properties of the thermoset product comprises comparing the one or more flow properties to the one or more calculated flow properties.

Embodiment 33. A three-dimensional (3D) object production system comprising:
extruded thermoset printing apparatus comprising:
an extrusion nozzle to deliver a thermoset product to form a 3D object,
at least one actuator operably coupled to the extrusion nozzle to move the extrusion nozzle when delivering thermoset product to form the 3D object,
a mixing chamber to receive and mix at least a first reactive component and a second reactive component to provide the thermoset product, and
a mass monitor to measure the mass of the 3D object while the 3D object is being formed; and
a controller comprising one or more processors and operably coupled to the extruded thermoset printing apparatus, wherein the controller is configured to:
   produce a 3D object based on the 3D object design using thermoset product delivered by the extruded thermoset printing apparatus;
   calculate a calculated mass of the 3D object during production thereof;
   measure an actual mass of the 3D object during production thereof using the mass monitor; and
   compare the calculated mass to the actual mass.

Embodiment 34. A three-dimensional (3D) object production method comprising:
providing extruded thermoset printing apparatus comprising:
   an extrusion nozzle to deliver a thermoset product to form a 3D object,
   at least one actuator operably coupled to the extrusion nozzle to move the extrusion nozzle when delivering thermoset product to form the 3D object,
   a mixing chamber to receive and mix at least a first reactive component and a second reactive component to provide the thermoset product, and
   a mass monitor to measure the mass of the 3D object while the 3D object is being formed;
producing a 3D object based on the 3D object design using thermoset product delivered by the extruded thermoset printing apparatus;
calculating a calculated mass of the 3D object during production thereof;
measuring an actual mass of the 3D object during production thereof using the mass monitor; and
comparing the calculated mass to the actual mass.

Embodiment 35. The system or method as set forth in Embodiment 33 or 34, wherein the controller is further configured to execute or the method further comprises adjusting one or more parameters of delivery and production of the thermoset product based on the comparison between the calculated mass and the actual mass.

Embodiment 36. The systems or methods as set forth in any one of Embodiments 33 to 35, wherein the controller is further configured to execute or the method further comprises:
initiating a cleaning event based on the comparison between the calculated mass and the actual mass.

Embodiment 37. A three-dimensional (3D) object production system comprising:
extruded thermoset printing apparatus comprising:
   an extrusion nozzle to deliver a thermoset product to form a 3D object,
   a mixing chamber to receive and mix at least a first reactive component and a second reactive component to provide the thermoset product, and
   a tip-wiping device to wipe the extrusion nozzle clean of thermoset product; and
a controller comprising one or more processors and operably coupled to the extruded thermoset printing apparatus, wherein the controller is configured to produce a 3D object based on the 3D object design using thermoset product delivered by the extruded thermoset printing apparatus.

Embodiment 38. The system of Embodiment 37, wherein the tip-wiping device is disposable.

Embodiment 39. A three-dimensional (3D) object production system comprising:
extruded thermoset printing apparatus comprising:
   an extrusion nozzle to deliver a thermoset product to form a 3D object,
   a mixing chamber to receive and mix at least a first reactive component and a second reactive component to provide the thermoset product, and
   a chamber defining a cavity within which the 3D object is formed; and
a controller comprising one or more processors and operably coupled to the extruded thermoset printing apparatus, wherein the controller is configured to:
   produce a 3D object in the chamber based on the 3D object design using thermoset product delivered by the extruded thermoset printing apparatus, and
   control one or more environmental parameters within the cavity of the chamber.

Embodiment 40. A three-dimensional (3D) object production method comprising:
providing extruded thermoset printing apparatus comprising:
   an extrusion nozzle to deliver a thermoset product to form a 3D object,
   a mixing chamber to receive and mix at least a first reactive component and a second reactive component to provide the thermoset product, and
   a chamber defining a cavity within which the 3D object is formed;
producing a 3D object in the chamber based on the 3D object design using thermoset product delivered by the extruded thermoset printing apparatus; and
controlling one or more environmental parameters within the cavity of the chamber.

Embodiment 41. The system or method as set forth in Embodiment 39 or 40, wherein the one or more environmental parameters comprises humidity, wherein controlling one or more environmental parameters within the cavity of the chamber comprises controlling the humidity within the cavity of the chamber to be within a selected range of humidity.

Embodiment 42. The system or method as set forth in any one of Embodiments 39 to 41, wherein the one or more environmental parameters comprises temperature, wherein controlling one or more environmental parameters within the cavity of the chamber comprises controlling the temperature within the cavity of the chamber.

Embodiment 43. A three-dimensional (3D) object production system comprising:
extruded thermoset printing apparatus comprising:
   an extrusion nozzle to deliver a thermoset product to form a 3D object,
   a mixing chamber to receive and mix at least a first reactive component and a second reactive component to provide the thermoset product, and
   a purge receptacle to receive thermoset product purged from the extrusion nozzle that is not used to form the 3D object; and
a controller comprising one or more processors and operably coupled to the extruded thermoset printing apparatus, wherein the controller is configured to produce a 3D object based on the 3D object design using thermoset product delivered by the extruded thermoset printing apparatus.

Embodiment 44. A three-dimensional (3D) object production system comprising:
extruded thermoset printing apparatus comprising:
   an extrusion nozzle to deliver a thermoset product to form a 3D object, and
   a mixing chamber to receive and mix at least a first reactive component and a second reactive component to provide the thermoset product; and
a controller comprising one or more processors and operably coupled to the extruded thermoset printing apparatus, wherein the controller is configured to:
   produce a 3D object based on a 3D object design using thermoset product delivered by the extruded thermoset printing apparatus, and
   adjust one or more parameters of producing the 3D object based on a reaction rate between the first reactive component and the second reactive component to provide the thermoset product, wherein
the one or more parameters comprise at least one of:
   a time per layer of thermoset product,
   a flow rate of the thermoset product through the extrusion nozzle,
   a viscosity of the thermoset product through the extrusion nozzle, and
   a cure acceleration of the thermoset product.

Embodiment 45. A three-dimensional (3D) object production method comprising:
providing extruded thermoset printing apparatus comprising:
   an extrusion nozzle to deliver a thermoset product to form a 3D object, and
   a mixing chamber to receive and mix at least a first reactive component and a second reactive component to provide the thermoset product;
producing a 3D object based on a 3D object design using thermoset product delivered by the extruded thermoset printing apparatus, and
adjusting one or more parameters of producing the 3D object based on a reaction rate between the first reactive component and the second reactive component to provide the thermoset product, wherein the one or more parameters comprise at least one of:
   a time per layer of thermoset product,
   a flow rate of the thermoset product through the extrusion nozzle,
   a viscosity of the thermoset product through the extrusion nozzle, and
   a cure acceleration of the thermoset product.

Embodiment 46. The system or method as set forth in Embodiment 44 or 45, wherein the one or more parameters further comprise temperature of the thermoset product, temperature of a platform upon which the 3D object is produced, temperature within a cavity of a chamber within which the 3D object is produced, temperature of the extrusion nozzle, and humidity within the cavity of the chamber within which the 3D object is produced.

Embodiment 47. The systems or methods as set forth in any one of Embodiments 44 to 46, wherein the 3D object design comprises an area defining a geometry, wherein the one or more parameters are adjusted to form the area based on the defined geometry.

Embodiment 48. The systems or methods as set forth in any one of Embodiments 44 to 47, wherein the 3D object design comprises an area defining a fill property, wherein the one or more parameters are adjusted to form the area based on the defined fill property.

Embodiment 49. A three-dimensional (3D) object production system comprising:
extruded thermoset printing apparatus comprising:
   an extrusion nozzle to deliver a thermoset product to form a 3D object,
   at least one actuator operably coupled to the extrusion nozzle to move the extrusion nozzle when delivering thermoset product to form the 3D object,
   a mixing chamber to receive and mix at least a first reactive component and a second reactive component to provide the thermoset product, and
   a controller comprising one or more processors and operably coupled to the extruded thermoset printing apparatus, wherein the controller is configured to:
produce a 3D object based on a 3D object design using thermoset product delivered by the extruded thermoset printing apparatus, and
adjust one or more parameters of the at least one actuator to produce the 3D object based on a reaction rate between the first reactive component and the second reactive component to provide the thermoset product, wherein the one or more parameters comprise at least one of:
a layer translation path;
a layer pattern;
a seam structure;
movement speed; and
corner speed.

Embodiment 50. A three-dimensional (3D) object production method comprising:
providing extruded thermoset printing apparatus comprising:
   an extrusion nozzle to deliver a thermoset product to form a 3D object,
   at least one actuator operably coupled to the extrusion nozzle to move the extrusion nozzle when delivering thermoset product to form the 3D object, and
   a mixing chamber to receive and mix at least a first reactive component and a second reactive component to provide the thermoset product, and
producing a 3D object based on a 3D object design using thermoset product delivered by the extruded thermoset printing apparatus; and
adjusting one or more parameters of the at least one actuator to produce the 3D object based on a reaction rate between the first reactive component and the second reactive component to provide the thermoset product, wherein the one or more parameters comprise at least one of:
a layer translation path;
a layer pattern;
a seam structure;
movement speed; and
corner speed.

Embodiment 51. The system or method as set forth in any one of Embodiments 1-50, wherein the controller is further configured to or the method further comprises producing the 3D object based on at least a selected resolution.

Embodiment 52. The system or method of Embodiment 51, wherein producing the 3D object based on a 3D object design using thermoset product delivered by the extruded thermoset printing apparatus comprises selecting a layer path and a flow rate of thermoset product based on the selected resolution.

Embodiment 53. The system or method as set forth in Embodiment 51 or 52, wherein producing the 3D object based on a 3D object design using thermoset product delivered by the extruded thermoset printing apparatus comprises selecting a resolution based on for each of a plurality of different areas of the 3D design.

Embodiment 54. A method of creating a three dimensional (3D) object from reactive components that form a thermoset product using extruded thermoset printing, comprising:
providing first and second reactive components that are effective to form a thermoset product having a predetermined layer resolution during the method;
introducing the first and second reactive components into a mixing chamber where mixing occurs to form a mixture,
   wherein the first and second reactive components have a residence time in the mixing chamber effective to form a partially reacted thermoset product in the mixing chamber and result in the predetermined layer resolution upon exiting the mixing chamber, and
   wherein the first and second reactive components have a residence time in the mixing chamber insufficient to completely react; extruding the partially reacted thermoset product out of the mixing chamber through an extrusion nozzle and onto a substrate; moving the extrusion nozzle and/or the substrate to form a 3D object having a predetermined shape resolution.

Embodiment 55. The method of Embodiment 54, wherein the thermoset product comprises a urethane and/or urea-containing polymer.

Embodiment 56. The method of Embodiment 54 or 55,
wherein the first reactive component comprises an isocyanate,
wherein the second reactive component comprises a polyol comprising at least one terminal hydroxyl group, a polyamine comprising at least one amine that comprises an isocyanate reactive hydrogen, or a combination of the polyol and the polyamine.

Embodiment 57. The method of any one of Embodiments 54 to 56, wherein the isocyanate comprises R—(N═C═O)ₙ, where n is at least 2.

Embodiment 58. The method of any one of Embodiments 54 to 57, wherein the isocyanate is a di-isocyanate (R—(N═C═O)₂).

Embodiment 59. The method of any one of Embodiments 54 to 58, wherein the R comprises an aliphatic group, a cyclic group or a combination thereof.

Embodiment 60. The method of any one of Embodiments 54 to 59, wherein the cyclic group comprises methylene diphenyl diisocyanate (MDI) or toluene diisocyanate (TDI).

Embodiment 61. The method of any one of Embodiments 54 to 60, wherein the MDI comprises monomeric MDI, polymeric MDI, or an isomer thereof.

Embodiment 62. The method of any one of Embodiments 54 to 61, wherein the isomer comprises the chemical formula C₁₅H₁₀N₂O₂.

Embodiment 63. The method of any one of Embodiments 54 to 62, wherein the isomer is 2,2′-MDI, 2,4′-MDI, 4,4′-MDI, or a combination thereof.

Embodiment 64. The method of any one of Embodiments 54 to 63, wherein the TDI is an isomer of TDI comprising the chemical formula C₉H₆N₂O₂.

Embodiment 65. The method of any one of Embodiments 54 to 64 wherein the isomer comprises 2,4-TDI, 2,6-TDI, or a combination thereof.

Embodiment 66. The method of any one of Embodiments 54 to 65, wherein the aliphatic group comprises a monomeric di-isocyanate, a blocked polyisocyanate, or a combination thereof.

Embodiment 67. The method of any one of Embodiments 54 to 66, wherein the monomeric di-isocyanate comprises hexamethylene diisocyanate (HDI), methylene dicyclohexyl diisocyanate, hydrogenated MDI (HMDI), isophorone diisocyanate (IPDI), or a combination thereof.

Embodiment 68. The method of any one of Embodiments 54 to 67, wherein the HDI comprises hexamethylene-1,6-diisocyanate.

Embodiment 69. The method of any one of Embodiments 54 to 68, wherein the HMDI comprises dicyclohexylmethane-4,4′diisocyanate.

Embodiment 70. The method of any one of Embodiments 54 to 69, wherein the blocked polyisocyanates comprise HDI trimer, HDI biuret, HDI uretdione, IPDI trimer, or a combination thereof.

Embodiment 71. The method of any one of Embodiments 54 to 70, wherein the polyol comprising at least one terminal hydroxyl group comprises a polyester, a polyether, or a combination thereof.

Embodiment 72. The method of any one of Embodiments 54 to 71, wherein the polyester comprises a compound resulting from condensation of phthalic anhydride and di-ethylene glycol, phthalic anhydride and di-propylene glycol, or adipic acid and butane diol.

Embodiment 73. The method of any one of Embodiments 54 to 72, wherein the polyether comprises a compound resulting from polymerization of an oxide selected from ethylene oxide, propylene oxide, or butylene oxide, from an initiator selected from glycerol, di-propylene glycol, TPG, castor oil, sucrose, or sorbitol.

Embodiment 74. The method of any one of Embodiments 54 to 73, wherein the polyol comprises a molecular weight of from 200 Daltons to 20,000 Daltons, such as from 200 Daltons to 10,000 Daltons.

Embodiment 75. The method of any of Embodiments 54 to 74, wherein the first reactive component comprises a prepolymer.

Embodiment 76. The method of any of Embodiments 54 to 75, wherein the prepolymer comprises an isocyanate prepolymer that comprises less than 20% unreacted isocyanate groups:

Embodiment 77. The method of any of Embodiments 54 to 76, wherein the isocyanate prepolymer comprises greater than 0.1% unreacted isocyanate groups.

Embodiment 78. The method of any of Embodiments 54 to 77, wherein the prepolymer comprises a polyol and/or amine prepolymer that comprises less than 14% unreacted alcohol groups.

Embodiment 79. The method of any of Embodiments 54 to 78, wherein the first and second reactive components comprise at least one additive selected from a catalyst, a chain extender, a curing agent, a surfactant, a pigment, a dye, a rheology modifier, a filler, or a combination thereof.

Embodiment 80. The method of any of Embodiments 54 to 79, wherein the first and second reactive components each comprise a viscosity of at least 60 centipoise (cP).

Embodiment 81. The method of any of Embodiments 54 to 80, wherein the first and second reactive components each comprise a viscosity from 500 cP to 500,000 cP.

Embodiment 82. The method of any of Embodiments 54 to 81, wherein the partially reacted thermoset product comprises a viscosity below 3,000,000 cP upon exiting the mixing chamber.

Embodiment 83. The method of any of Embodiments 54 to 82, wherein the partially reacted thermoset product does not increase pressure present in the mixing chamber by more than 20% in 5 minutes.

Embodiment 84. The method of any of Embodiments 54 to 83, wherein the ratio of viscosity of the first and second reactive components is from 1:3 to 3:1.

Embodiment 85. The method of any of Embodiments 54 to 84, wherein the substrate comprises a stage.

Embodiment 86. The method of any of Embodiments 54 to 85, wherein the substrate comprises a previously formed and partially reacted thermoset product, or a previously formed and completely reacted thermoset or thermoplastic product, or a metal product.

Embodiment 87. The method of any of Embodiments 54 to 86, wherein the 3D object comprises more than one type of material.

Embodiment 88. The method of any of Embodiments 54 to 87, wherein the 3D object comprises a solid thermoset product.

Embodiment 89. The method of any of Embodiments 54 to 88, wherein the solid thermoset product comprises a Shore A hardness of 20 to 120.

Embodiment 90. The method of any of Embodiments 54 to 89, wherein the solid thermoset product comprises a Shore D hardness of at least 30 to no greater than 120.

Embodiment 91. The method of any of Embodiments 54 to 90, wherein the 3D object comprises a foam thermoset product.

Embodiment 92. The method of any of Embodiments 54 to 91, wherein the foam comprises a 25% IFD hardness of at least 15 lbs. to no greater than 60 lbs.

Embodiment 93. The method of any of Embodiments 54 to 92, wherein the foam comprises a compression resistance at 10% deflection of 25 to 200 kPa.

Embodiment 94. The method of any of Embodiments 54 to 93, wherein the foam comprises a bending strength of 150 and 2000 kPa.

Embodiment 95. The method of any of Embodiments 54 to 94, wherein the foam comprises a density of no less than 0.05 gram/milliliter (g/ml) to no greater than 1.3 g/ml.

Embodiment 96. A 3D object comprising a completely reacted thermoset product, wherein the completely reacted thermoset product comprises a solid thermoset product and a foam thermoset product, wherein a portion of the solid thermoset product and a portion of the foam thermoset product are covalently bonded.

Embodiment 97. The 3D object of Embodiment 96, wherein the solid thermoset product comprises a Shore A hardness of 20 to 120.

Embodiment 98. The 3D object of any of Embodiments 96 or 97, wherein the solid thermoset product comprises a Shore D hardness of at least 30 to no greater than 120.

Embodiment 99. The 3D object of any of Embodiments 96 to 98, wherein the foam thermoset product comprises a 25% IFD hardness of at least 15 lbs. to no greater than 60 lbs.

Embodiment 100. The 3D object of any of Embodiments 96 to 99, wherein the foam comprises a density of no less than 0.05 g/ml to no greater than 1.3 g/ml.

Embodiment 101. The 3D object of any of Embodiments 96 to 100, wherein the hardness of the foam thermoset product varies between two separate areas of the foam thermoset product of the 3D object.

Embodiment 102. The 3D object of any of Embodiments 96 to 101, wherein the density of the foam thermoset product varies between two separate areas of the foam thermoset product of the 3D object.

Embodiment 103. A 3D object comprising a completely reacted solid thermoset product, wherein the hardness of the completely reacted solid thermoset product varies between two separate areas of the solid thermoset product of the 3D object.

Embodiment 104. The 3D object of Embodiment 103, wherein the solid thermoset product comprises a Shore A hardness of 20 to 120.

Embodiment 105. The 3D object of Embodiment 103 or 104, wherein the solid thermoset product comprises a Shore D hardness of at least 30 to no greater than 120.

Embodiment 106. A 3D object comprising a completely reacted foam thermoset product, wherein the hardness of the completely reacted foam thermoset product varies between two separate areas of the solid thermoset product of the 3D object.

Embodiment 107. The 3D object of Embodiment 106, wherein the foam thermoset product comprises a 25% IFD hardness of at least 15 lbs. to no greater than 60 lbs.

Embodiment 108. A 3D object comprising a completely reacted foam thermoset product, wherein the density of the completely reacted foam thermoset product varies between two separate areas of the solid thermoset product of the 3D object.

Embodiment 109. The 3D object of Embodiment 108, wherein the foam comprises a density of greater than 0.05 g/ml to no greater than 1.3 g/ml.

Embodiment 110. The method of any one of Embodiments 54 to 95 further comprising providing one or more additional reactive components, wherein the one or more additional reactants are introduced into the mixing chamber.

Embodiment 111. The method of any one of Embodiments 54 to 95 or 110, wherein introducing the one or more additional reactive components results in a 3D object comprising a property that varies between two separate areas of the 3D object.

Embodiment 112. The method of any one of Embodiments 54 to 95, 110 or 111, wherein the property that varies comprises hardness, density, or a combination thereof.

Embodiment 113. The method of any one of Embodiments 54 to 95 or 110 to 112, wherein the 3D object comprises a solid thermoset product.

Embodiment 114. The method of any one of Embodiments 54 to 95 or 110 to 113, wherein the 3D object comprises a foam thermoset product.

Embodiment 115. The method of any one of Embodiments 54 to 95 or 110 to 114, wherein the 3D object comprises solid thermoset product and foam thermoset product.

Embodiment 116. A thermoset system comprising a first and a second reactive component,
wherein the first component comprises a polyol and/or amine prepolymer, a fast reactant, and a slow reactant, wherein the first component comprises 1% to 10% fast reactant and 1% to 75% slow reactant, and
wherein the second component comprises an isocyanate prepolymer that comprises a monomeric isocyanate.

Embodiment 117. The thermoset system of Embodiment 116, wherein the fast reactant comprises a chain extender.

Embodiment 118. The thermoset system of Embodiment 116 or 117 wherein the chain extender comprises a di-amine, water, a primary hydroxyl reaction group, or a combination thereof.

### EXAMPLES

The 3D object production system and methods disclosed herein are now further detailed with reference to the following examples. These examples are provided for the purpose of illustration only and the embodiments described herein should in no way be construed as being limited to these examples. Rather, the embodiments should be construed to encompass and an all variations which become evidence as a result of the teaching provided herein.

### Example 1A

An apparatus capable of dispensing accurate amounts of several reactive components can be used to create 3D objects with a range of physical properties.

### Process

A 3D Model portraying the filled star (shown in FIG. 4) was created using the Solidworks™ 2018 CAD software and exported as an STL file. The model was designed with (1) a raised outline and (2) an inner flat area.

The STL file was processed using an off the shelf “slicing” application to create G-Code descriptions of the actions required to create each individual area with a unique thermoset material.

Area 1, the outer raised area of the star, was built using Thermoset 1, having a red color and a hardness of Shore 60A. Area 2, the inner filled area of the star was built using Thermoset 2, having a green color and a hardness of Shore 95A

As shown in Table 1, Thermoset 1 was produced by mixing using two reactive components, A1 and B1; Thermoset 1 was produced by mixing using two reactive components, A2 and B2:

TABLE 1

| | |
|---|---|
| Reactive component A1 | Reactive component A2 |

| | | | |
|---|---|---|---|
| Isocyanate | | Isocyanate | |
| Prepolymer | | Prepolymer | |
| Red tint | | Yellow tint | |
| Starting viscosity | 5300 cp | Starting viscosity | 5300 cp |

| | |
|---|---|
| Reactive component B1 | Reactive component B2 |

| | | |
|---|---|---|
| Polyol | | Polyol |
| Prepolymer | | Prepolymer 2 |
| Blue Tint | | Blue Tint |
| Starting Viscosity | 2660 cp | |

The ratio of isocyanate:prepolymer was lower for Reactive component A1 compared to Reactive component A2. Reactive component B2 had a larger weight percentage of prepolymer as compared to Reactive component B1.

The model was printed in two separate operations using a Hyrel™ Engine SR printer with a modified CSD-30 Extruder.

### Operation 1

The outer star was printed using Thermoset 1 to produce 6 layers of a geometric pattern defined by the slicing application. Each layer was deposited using the following parameters.
Bead height: 0.8 mm
Bead width: 1.2 mm
Linear speed: 25 mm/s
Flowrate: 24 mm³/s

### Operation 2

The inner filled star was printed using Thermoset 2 to produce 4 layers of a geometric pattern defined by the slicing application with the same parameters.

The printed object shown in FIG. 4 demonstrates that (1) each thermoset material is capable of forming a dimensionally accurate representation of the 3D model created by the CAD program, and (2) the two thermoset materials bond to form a single object with unique properties, in this case color and hardness.

### Example 1B

Example 1A was created using a Hyrel™ extruder that is only capable of extruding two reactive components at any time. The addition of an extruder capable of combining and extruding multiple reactive components will allow:
1. Areas with unique properties to be extruded simultaneously; and
2. Reactive components to be blended in precise ratios to create specific properties from reactive components with specific unique properties.

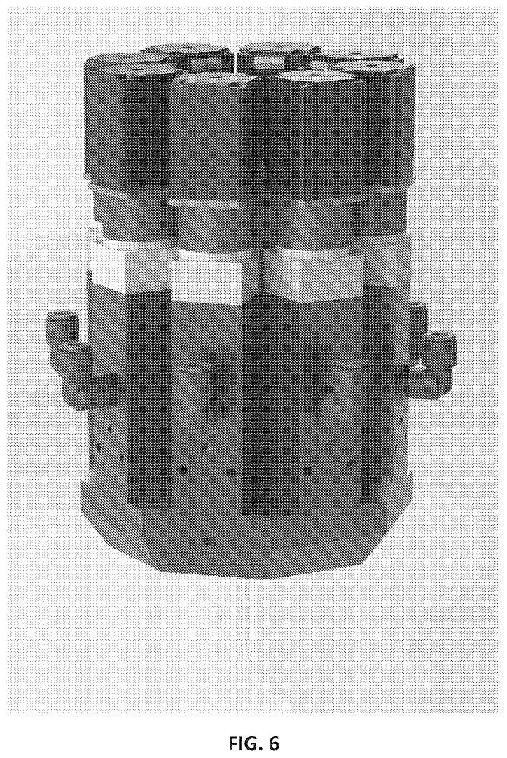

FIG. 6 shows an extruder capable of combining up to 8 reactive components.

This type of extruder in FIG. 6 would be capable of creating the star in a single operation by selectively extruding reactive components A1 and B1 to create Thermoset 1 while describing the outer raised area of the star shown in FIG. 1 and extruding reactive components A2 and B2 to create Thermoset 2 while describing the inner filled area of the star shown in FIG. 4. Additionally, this type of extruder could create areas with blended properties by combining Thermosets 1 and 2 in specific ratios.

For example, the extruder in FIG. 6 could be used as shown in Table 2:

| | | |
|---|---|---|
| Thermoset 1 | Thermoset 2 | Hardness |

| | | | | |
|---|---|---|---|---|
| 100% | (24 mm³/s) | 0% | (0.00 mm³/s) | Shore 60A |
| 50% | (12 mm³/s) | 50% | (12 mm³/s) | Shore 75A |
| 0% | (0.00 mm³/s) | 100% | (24 mm³/s) | Shore 90A |

In this way, combining reactive components can generate specific properties, including hardness, color, optical refractive index, density (foam), and porosity (foam), in precise ratios and can create blended properties within defined areas of the model being constructed.

By providing the “slicing” application with a mechanism to understand the relationship between the mix ratios of each of the reactive components and each specific property, a continuous spectrum of properties may be created.

For example, to print the star described in Example 1A in a single operation with the hardness of each point within the model being specified be achieved by the following steps.

By storing a description of each reactive component A1, A2, B1, and B2 within the slicing application and by using those parameters within a proprietary algorithm the slicing application would generate G-Code with description of the flowrate used to create a parameter value.

This G-Code description could allow a properly configured 3D object manufacturing system to control the flowrate of 4 reactive components to create a thermoset material with a hardness blended between Shore 60A and Shore 90A.

The addition of colored tints in the proper ratio would allow the system described above to create blended colors. The addition of water in the proper ratio would allow the system described above to generate foam with a specified density and porosity.

### Example 2

Obstructions within the mixing chamber or extrusion nozzle of the extrusion system described in Example 1 can occur for a variety of reasons. Identification of an obstruction and the initiation of corrective actions are a fundamental to the development of a productive system for the creation of 3D objects with thermosets.

To identify an obstruction the operating parameters of the extrusion system and the reactive component flow must be monitored and compared against normal operating conditions.

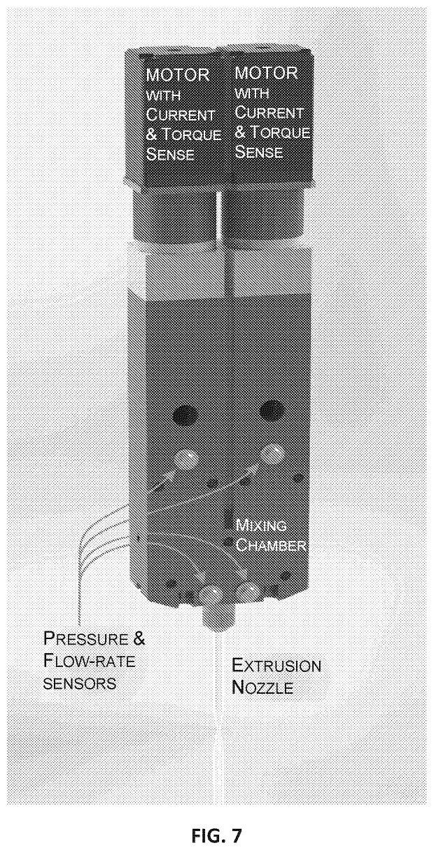

FIG. 7 shows an extrusion system similar to that shown in FIG. 6. Both systems use several identical ViscoTec™ 5/5 liquid pumps feeding a mixing chamber with an extrusion nozzle. FIG. 4 shows 2 liquid pumps for simplicity.

### Motor Current/Torque

The current drawn by each motor driving a liquid pump can be measured. For a DC motor, the torque required to drive the liquid pump can be proportional to the current drawn by the motor.

Obstructions in the extrusion system led to the motor driving the liquid pump delivering more torque and therefore causing the motor to draw a higher current.

In normal operating, the current drawn by the motors driving the ViscoTec™ 5/5 liquid pump range is between 0.5 A and 1.25 A. While peaks above 1.25 A are possible extended current draws of greater than 1.25 A strongly suggest the presence of an obstruction.

### Reactive Component Pressure

The pressure of a reactive component can be measured using a pressure transducer. The pressure of each reactive component can be measured prior to the liquid pump and within the mixing chamber, prior to the extrusion nozzle.

Obstructions can be characterized by an increase in pressure in the mixing chamber and are strongly suggested when the pressure in the mixing chamber becomes higher than the pressure prior to the liquid pump.

Actual reactive component pressures depend on the viscosity of the component but for a component with a viscosity of 40,000 cP a pressure of 80 psi prior to the liquid pump is typical and while the pressure at the extrusion nozzle increases to create increased flow the pressure in the mixing chamber should remain significantly below 60 psi.

### Reactive Component Flowrate

The flowrate of a reactive component can be measured using variety of sensor technologies. The flowrate of each reactive component is measures prior to the liquid pump and at the outflow of the mixing chamber.

Obstructions can cause either a complete or part reduction of the flow of material. Unfortunately, a lack of material or a pressure failure can also cause the material flowrate to reduce or stop completely. By measuring both the pressure and material flowrate prior to the liquid pump and at the outflow of the mixing chamber the presence of an obstruction be ascertained. The logic table used to identify the likelihood of an obstruction is shown in Table 3 below:

TABLE 3

| | Prior to liquid pump | | | Mixing chamber outflow | | | | |
|---|---|---|---|---|---|---|---|---|
| | Flowrate | | Pressure | Flowrate | | Pressure | | State |
| 1 | 0.05-6.0 | ml/s | 80 psi | Same as prior to | | 0-60 | psi | Normal |
| | | | | pump | | | | |
| 2 | 0 | ml/s | 80 psi | 0.05-6.0 | ml/s | 0-60 | psi | Out of material |
| 3 | 0 | ml/s | 80 psi | 0 | ml/s | 0 | psi | Out of material |
| 4 | 0 | ml/s | 0 psi | 0.05-6.0 | ml/s | 0-60 | psi | Input pressure |
| | | | | | | | | failure |
| 5 | 0.05-6.0 | ml/s | 80 psi | Less than prior to | | 0-60 | psi | Likely |
| | | | | pump | | | | obstruction |
| 6 | 0.05-6.0 | ml/s | 80 psi | Same as prior to | | 60-80 | psi | Likely |
| | | | | pump | | | | obstruction |
| 7 | 0.05-6.0 | ml/s | 80 psi | Same as prior to | | >80 | psi | Very likely |
| | | | | pump | | | | obstruction |
| 8 | 0.05-6.0 | ml/s | 80 psi | 0 | ml/s | >80 | psi | Very likely |
| | | | | | | | | obstruction |
| 9 | 0 | ml/s | 80 psi | 0 | ml/s | >80 | psi | Extremely likely |
| | | | | | | | | obstruction |

The ViscoTec™ 5/5 liquid pump can accurately pump liquids at a rate of between 0.05 ml/s and 6.0 ml/s

### Reactive Component Mass

In normal operation, the ViscoTec™ 5/5 extruder is capable of very accurately metering the volume of reactive components extruded.

The cumulative volume of material that is intended to be extruded is noted by the G-Code interpreter running on the 3D printer throughout the production of an object.

By adding force sensors to each corner of the build surface the mass of extruded material can be measured throughout the production of the 3D object.

By monitoring the difference between the intended mass of material to be extruded and the actual mass as measured by the force sensors mounted on the build surface it can be determined if the actual mass of material deposited is significantly less than that intended, suggesting a potential obstruction.

### The Color of the Combined Reactive Components

By mounting a color sensor such as the AMS AS7261 Tri-stimulus XYZ_NIR Sensor in the extrusion nozzle, the color of the combined thermoset can be measured.

The color of each reactive component can be controlled by the addition of a tint. The color of the final thermoset can be controlled by the mixture of the tints present in each component. In Example above Reactive component A1 contains a red tint, Reactive component A2 contains a yellow tint, Reactive component B1 contains a blue tint, and Reactive component B2 contains a blue tint.

Combination of any of these components could produce a thermoset with a unique color. Absence or a reduction in the amount of any of the components could result in the extruded thermoset having a measurably different color. Identification of the missing color constituent would suggest a potential obstruction in the extrusion system for that component.

### Spectral Analysis of the Combined Reactive Components

By mounting a multi-spectral imaging sensor such as the AMS AS7265x Smart Spectral Sensor within the extrusion nozzle the chemical composition of the extruded material can be characterized.

By comparing the predicted chemical composition of the extruded material against that measured by the sensor would allow the absence of chemical constituents related to a specific reactive component would suggest a potential obstruction in the extrusion system for that component.

### Potential Actions

Initiate a delay and notify the operator
Initiate an automated cleaning cycle and notify the operator
Initiate an automated purge of the affected material
Request that the operator initiate a manual cleaning procedure

### Optimization of Obstruction Identification

Historical data for each sensor reading could be collected and stored within the 3D printer control system to optimize the identification of obstructions. For example, the pressure limits for each type of reactive component would be monitored and updated during normal operation to provide a more accurate understanding of sensor values that would suggest an obstruction.

### Example 3

The system described in Example 2 makes use of flowrate sensors to help identify obstructions within each component extrusion system. Those sensors can also be used during normal operation to compensate for inconsistencies in the flowrate caused by variations in the reactive component parameters or tolerances in hardware such as the extruder nozzle.

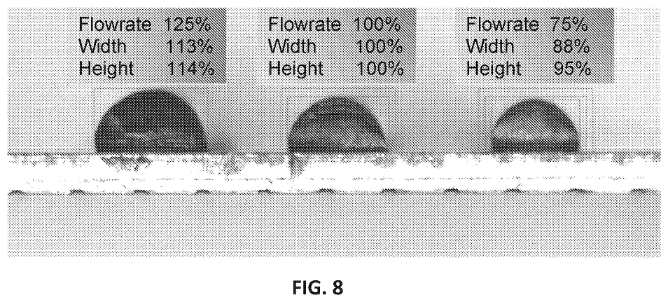

As can be seen in FIG. 8, small changes in the flowrate of each reactive component can cause non-linear changes to the printed bead height and width.

FIG. 8 shows a cross section of three beads printed using a German RepRap x400i LAM printer with a ViscoTec™ Duo extruder. Each bead was printed with a thermoset material comprised by 2 reactive components, A1 and B1, as shown in Table 4.

TABLE 4

| | |
|---|---|
| Reactive component A1 | Reactive component B1 |

| | | | |
|---|---|---|---|
| Isocyanate | | Polyol | |
| Prepolymer | | Blue tint | |
| Red tint | | Starting viscosity | 40,000 cP |
| Starting viscosity | 40,000 cP | | |

For the material shown above with an unreacted viscosity of 40,000 cP:
100% flowrate (6.0 mm³/s) creates a bead;
   Bead width: 0.9 mm
   Bead height 0.675 mm
75% flowrate (4.0 mm³/s) creates a bead;
   Bead width: 0.782 mm
   Bead height 0.645 mm
125% flowrate (8.0 mm³/s) creates a bead;
   Bead width: 1.017 mm
   Bead height 0.766 mm

Variations in the bead width and particularly the bead height can reduce the quality of the printed object. By monitoring the difference between the desired flowrate and the actual flowrate a Proportional, Derivative, Integral (PID) control algorithm can be employed to optimize the desired flow using a control loop feedback mechanism resulting in a more accurate and stable flow and a more consistent printed bead.

### Example 4

The extrusion nozzle described in the previous examples can in certain circumstances accumulate parts of reacted thermoset material on the tip of the nozzle. This “blob” of material can interfere with any previously printed material marking the print and potentially mis-align the extrusion nozzle.

The slicing application can identify opportunities to complete an automated tip cleaning process during the print. The tip cleaning process can cause the extruder to move to the edge of the build platform where a cleaning wipe can remove any accumulated material from the extrusion nozzle.

The cleaning wipe can be located at the beginning of each print and replaced after the print is completed.

### Example 5

Thermoset materials such as those described can be affected by the environmental conditions in which they are contained.

The viscosity, flowrate, and reaction rate of a partly reacted thermoset material can depend on its temperature.

Deposition of thermoset material in a high relative humidity environment can cause bubbles in the cured material.

The German RepRap™ x400i LAM printer is surrounded by a sealed enclosure with integrated sensor and control systems allowing environmental conditions to be monitored and controlled.

The enclosure is connected to an air-line providing cool (15° C.) air with a relative humidity of 0% and kept under positive pressure. Air is introduced at a rate to maintain a relative humidity of less than 15% within the enclosure. Temperature can be maintained at a constant temperature between 15° C. and 25° C. Consistent temperature can provide beneficial 3D printing conditions.

### Example 6

As described in Example 5, the viscosity, flowrate, and reaction rate of a thermoset material can depend on temperature.

By monitoring the temperature of the thermoset material, the temperature of the build surface (build plate) and the temperature of the environment within the enclosure described above a number of printing parameters can be optimized for temperature, including;
a. Time per layer of the thermoset product,
b. Flow-rate of the extruded thermoset product, and
c. The Viscosity of the extruded thermoset product

### Time Per Layer

Each thermoset material has an associated reaction rate. This rate can provide an indication of the rate at which the material will reach a gel state. The reaction rate and therefore the time taken to reach a gel state can depend on temperature. With the reaction rate increasing with temperature and the time taken to reach a gel state reducing.

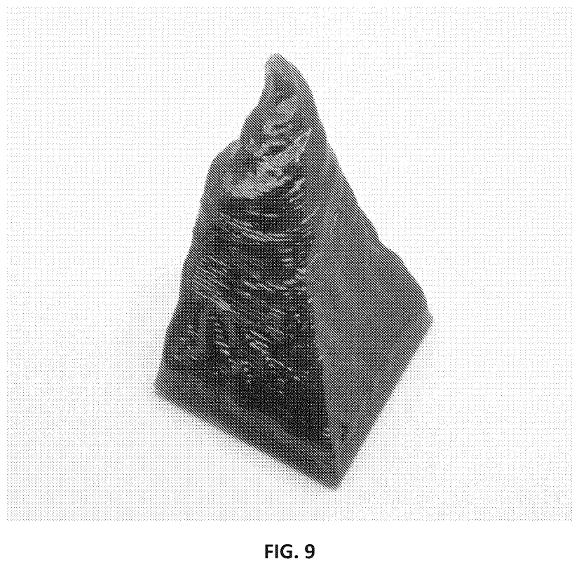

FIG. 9 shows an offset pyramid printed with the material described in Example 3. This material reaches a gel state in approximately 90 seconds at 25 C. At this point the material is self-supporting and resists flow.

The offset pyramid print contains approximately 50 layers printed with the following parameters:
Bead height: 0.675 mm
Bead width: 0.75 mm
Linear speed: 12 mm/s
Flowrate: 6.075 mm³/s

Each new layer can be extruded onto a previous layer which has reached a gel state. As the area of each layer reduces the time required to print each layer also reduces from approximately 3.5 minutes at the pyramid's base to under 10 seconds at the pyramid's peak.

Once approximately half the layers have been printed the time taken to print a layer is less than the time taken to reach a gel state and the subsequent layer is deposited onto a liquid surface causing the print to become unstable.

To create a stable object each layer should have reached a gel state before the next layer is deposited. This can be achieved two ways.
a. The print can pause to allow the prior layer to reach a gel state.
   The duration of each pause will be;

Pause Duration=Gel Time−Layer Print Time
For example a layer that takes 30 sec to deposit has a 60 sec delay before the next layer is deposited.
b. The reaction rate of the thermoset material could be increased by the addition of an additional reactive component.
   For example, the thermoset described above with a gel time of 90 seconds at 25 C could have additional catalyst added using an additional component pump, increasing the materials reaction rate and reducing its gel time.

Using the temperature data described in Example 5, the printer control system could be optimized to generate a more accurate inter-layer delay based on a more accurate understanding of the gel time and temperature. For example, shown in Table 5:

TABLE 5

| Temperature | Gel Time |
|---|---|
| 15° C. | 102 s |
| 20° C. | 95 s |
| 25° C. | 90 s |
| 30° C. | 86 s |
| 35° C. | 82 s |

### Viscosity/Flowrate

As has been shown in the previous examples:
any change in flowrate can cause a change in the height and width of any extruded bead
any change in temperature can causes a change in the viscosity and flowrate of the extruded material

Using the temperature data described in Example 5, the printer control system could be optimized to correct the desired flowrate for the current temperature of the enclosure, build plate or material.

### Example 7

Each object is built within a 3-dimensional space described by three perpendicular axis, X, Y and Z.

### Seam Structure

The seam is the vertical line formed when each layer begins printing at the same X, Y point. For example, if each layer starts printing from the following coordinates in (X, Y, Z) space a vertical line can become visible on the object due to variations in the starting flowrate of the extruded material.
a. Layer 5—(100.000, 100.00, 4.000)
b. Layer 4—(100.000, 100.00, 3.000)
c. Layer 3—(100.000, 100.00, 2.000)
d. Layer 2—(100.000, 100.00, 1.000)
e. Layer 1—(100.000, 100.00, 0.00)

The seam structure can be optimized by moving the starting point of adjacent layers to random locations within the layer.

### Corner Speed

Ideally an extruded bead of thermoset material can be made to change direction instantaneously. The physical properties of each unique thermoset material can include its ability to change direction.

As each curve in a 3D printed bead is made up from several linear segments this ability to change direction can be expresses as a maximum angular velocity where;

$$maximum angular velocity ω = \frac{d θ}{dt}$$

and where θ is the corner angle
   and
maximum linear velocity v=ωr
where r is the radius of the corner

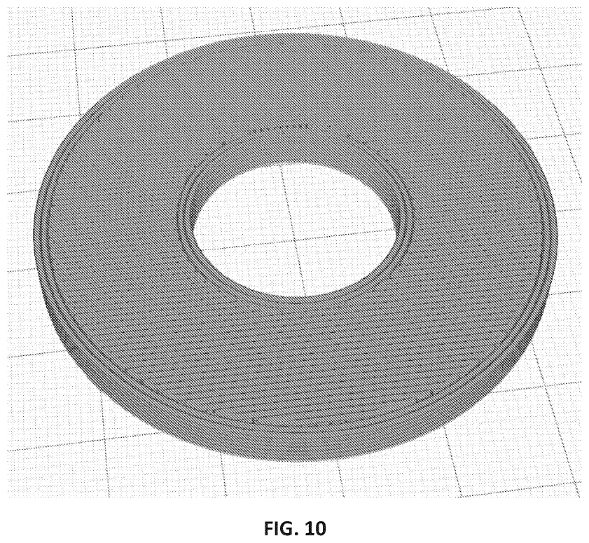

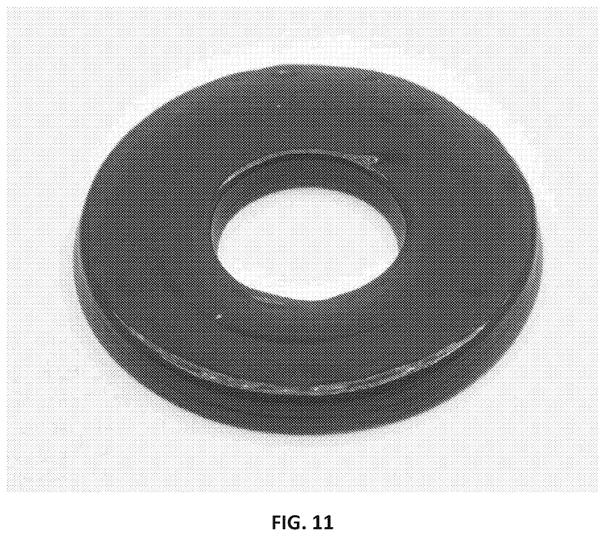

FIG. 10 and FIG. 11 show a flattened donut printed with the thermoset material described in Example 3.

The object was printed using the following print parameters:
a. Bead height: 0.675 mm
b. Bead width: 0.75 mm
c. Linear speed: 12 mm/s
d. Flowrate: 6.075 mm³/s
e. Fill pattern: Concentric
f. Corner speed: 72 degrees per second

Given a corner speed of 72 degrees per second and a radius of 20 mm the linear speed would be 12 mm/s.

Optimizing the geometry, resolution and print speed in concert with the thermoset flow-rate can be key to creation of an accurate 3D representation of a 3D model.

### FORMULATION EXAMPLES

Liquid blends of isocyanate prepolymers and neat isocyanates were prepared at various ratios to form an isocyanate component, and then were mixed with a formulation of polyols, amines, and catalysts. The mixture of the two components was extruded through a static mixer at a given rate and residence time.

Final properties of the exiting materials were measured using a Shore A hardness gauge. A viscosity profile was created using Brookfield viscometer measurements utilizing different viscometer temperature settings and torque ranges to determine and predict the speed of reaction of the formulated materials.

Monomeric MDI (Diphenymethane-4,4′-diisocyanate) was obtained from BASF Corporation (Lupranate™ MI). Technical grade TDI (80% Tolylene-2,4-diisocyanate, 20% Tolylene-2,6-diisocyanate) was obtained from Sigma-Aldrich. Pluracol™ polyols were obtained from BASF Corporation. Ethacure™ 100 and Ethacure™ 300 amines were obtained from Albemarle Corporation.

### Isocyanate Prepolymer Syntheses

Pluracol™ 1010 TDI Prepolymer: 72 wt % Pluracol™ 1010, 28% TDI.

Pluracol™ 2010 TDI Prepolymer: 83.6 wt % Pluracol™ 2010, 16.4% TDI.

Pluracol™ 1010 MDI Prepolymer: 64 wt % Pluracol™ 1010, 36 wt % Lupranate™ MI.

Pluracol™ 2010 MDI Prepolymer: 80% Pluracol™ 2010, 20% Lupranate™ MI.

Isocyanate was heated in the reaction vessel to 80° C. Polyol was added over two hours while maintaining the reaction temperature between 8° and 85° C. Reaction vessel was maintained at 80° C. for an additional two hours. Reaction mixture was stirred and blanketed with nitrogen throughout the reaction. At the end of the reaction, the mixture was cooled and poured into storage.

### Polyol Prepolymer Synthesis

Polyol Prepolymer 1: Pluracol™ polyol was heated to 80° C. Isocyanate addition rate was set to add entire amount over two hours. After 75 minutes, butanediol addition was commenced such that the butanediol was added over 45 minutes. After addition was completed, reaction mixture was held for two hours. During entire reaction, temperature was held between 8° and 85° C. Reaction mixture was stirred and blanketed with nitrogen through the reaction. At the end of the reaction, the mixture was cooled and poured into storage.

Composition was 62% Pluracol™ 1010, 26.8% Lupranate™ MI, 11.2% butanediol.

Polyol Prepolymer 2: Butanediol was heated to 80° C. Isocyanate prepolymer was added over two hours. Reaction mixture was held for two hours. During entire reaction, temperature was held between 8° and 85° C. Reaction mixture was stirred and blanketed with nitrogen through the reaction. At the end of the reaction, the mixture was cooled and poured into storage.

Composition was 12% butanediol, 88% PI 1010 MDI prepolymer.

### Mixing Properties

An isocyanate formula and a polyol were loaded into syringes and pumped through a junction to a static mixer. At the end of the static mixer, the combined materials flowed through a nozzle. The static mixer had a volume of 2.37 mL and included 12 mixing elements. Total flow rates were varied from 2 to 8 mL/min.

The examples below show that the relative viscosities of the component formulas affected the quality of the mixing in the static mixer. Mixing quality was rated from 1 to 3. Mixing rated as a “1” was poor: visual observations of the material inside the mixer and exiting the mixer showed distinct material separation. Mixing rated as a “2” appeared mixed upon exiting the mixer, but the final part had a noticeable swirl pattern and had a liquid residue on the surface. Mixing rated as a “3” was excellent: the completely reacted material cured and had final properties indistinguishable from material that was vigorously mixed in a cup and cured.

The isocyanate formula was either straight prepolymer or a blend of monomeric isocyanate and an isocyanate prepolymer. The polyol formula was a blend of amine, polyol, and catalyst. In Example 8, an isocyanate formula with a viscosity of 8,000 cps was mixed with a polyol formula with a viscosity of 100 cps, and showed poor mixing. In Example 12, an isocyanate formula with viscosity of 7,000 cps and a polyol formula with viscosity of 2,500 cps showed excellent mixing.

TABLE 6

| | | | | Isocyanate | Polyol | |
|---|---|---|---|---|---|---|
| | | Prepolymer | | formula | formula | Mixing |
| | Reference | Isocyanate | | viscosity | viscosity | Quality |
| Example | Number | Type/Mix | Mix ratio | (cps) | (cps) | result |
| 8 | C3DM1-38 | TDI 100% | 6.32:1 | 8,000 | 100 | 1 |
| 9 | C3DM1-40 | TDI 100% | 10.25:1 | 5,000 (25° C.) | 100 | 1 |
| 10 | C3DM1-43 | TDI 100% | 10.25:1 | 1,000 (50° C.) | 100 | 2 |
| 11 | C3DM1-70 | MDI 80/20 | 1:1.2 | 7,000 | 100 | 1 |
| 12 | C3DM4-22 | MDI 80/20 | 1.1:1 | 7,000 | 2,500 | 3 |

TABLE 7
Formulas

| | C3DM1- | C3DM1- | C3DM1- | C3DM1- | C3DM4- |
|---|---|---|---|---|---|
| | 38 | 40 | 43 | 70 | 22 |
| A-side | | | | | |
| Pl 1010 TDI | 100% | | | | |
| prepolymer | | | | | |
| Pl 2010 TDI | | 100% | 100% | | |
| prepolymer | | | | | |
| Pl 1010 MDI | | | | 79.7% | 80% |
| prepolymer | | | | | |
| MDI | | | | 20.3% | 20% |
| B-side | | | | | |
| Ethacure ™ 300 | 23.8% | | | | |
| Ethacure ™ 100 | 69.2% | 100% | 100% | 5.0% | 7.2% |
| Pl 1010 | 7.0% | | | 93.2% | 64.0% |
| Polyol prepolymer 2 | | | | | 27.5% |
| Dabco ™ 33LX | | | | 1.0% | 0.7% |
| Dabco ™ T12 | | | | 0.8% | 0.6% |

Viscometer settings: Isocyanate formulas C3DM1-38,40,43 used spindle 31 at 6 RPM. Formulas C3DM1-70 and C3DM4-22 used spindle 27 at 6 RPM. All measurements at 20@C except for sample C3DM1-43 which was measured at 50° C. Polyol formulas C3DM1-38, 40, 43, 70 were measured at 20° C., 30 RPM, Spindle 18. Polyol formula for C3DM4-22 used spindle 27 at 20° C., 6 RPM.

### Viscosity Growth During Cure

Viscosity growth rate during cure is a useful parameter for achieving printable materials.

Examples below show that different formulas yield different viscosity profiles after being mixed. Formulation changes related to the concentration of reactive groups, reactivity of formula components, and catalyst levels can independently affect the growth of viscosity during cure.

The viscosity profiles were measured by rapidly mixing the two formula components, pouring 10 grams of the reacting mixture into a Brookfield viscometer sample cup, and then recording the viscosity as a function of time.

### Examples 13 and 14

### Pure Isocyanate Vs Prepolymer

In Example 13, the formula (C3DM1-85) used an isocyanate formula with Toluene di isocyanate (TDI) 87 g/mol of isocyanate. The isocyanate formula was reacted with a mixture of Ethacure™ 100 and Pluracol™ 201f0, with a reaction equivalent density of 482 g/mol. The isocyanate and polyol formulas were mixed with a ratio of 1:5.28 for a 4% stoichiometric excess of isocyanate.

In Example 14, the formula (C3DM1-81) used an isocyanate formula with 870 g/mol isocyanate. This isocyanate formula contained a prepolymer made by reacting Pluracol™ 2010 with MDI with the entire polyol content of the first reaction pre-reacted with the isocyanate. This formula was reacted with an amine Ethacure™ 100 with a reaction equivalent density of 89 g/mol. The isocyanate and amine chain extender formulas were mixed with a ratio of 10.2:1 for a 4% stoichiometric excess of isocyanate.

Example 13 had a very high density of highly labile isocyanate groups, and cured very quickly, while Example 14 had a density of isocyanate groups which is ten times lower, and cured much more slowly. The formulas used are given below:

TABLE 8
C3DM1-85

| | Amount (g) |
|---|---|
| A-side | |
| TDI | 1.93 |
| B-side | |
| PL2010 polyol | 9.16 |
| Ethacure ™ 100 | 1.04 |

TABLE 9
C3DM1-81

| | Amount (g) |
|---|---|
| A-side | |
| PL2010 TDI | 15.48 |
| prepolymer | |
| B-side | |
| Ethacure ™ 100 | 1.52 |

TABLE 10

| Time | Example 13 C3DM1-85 | Example 14 C3DM1-81 |
|---|---|---|
| (min) | Viscosity (cps) | Viscosity (cps) |
| 0 | 1,000 | 5,000 |
| 1 | 300,000 | |
| 1.5 | 780,000 | |
| 2 | cured | 5650 |
| 3 | | 11,000 |
| 4 | | 34,100 |
| 5 | | 59,000 |
| 6 | | 91,000 |
| 10 | | 708,000 |

Viscometer settings: 22° C., 0.3 RPM, spindle 27.

### Examples 15 and 16

### Effect of Catalyst

These examples show the effect of different catalyst on the cure rate. Example 15 (C3DM-86) had a different catalyst than Example 16 (C3DM1-102). Samples with different catalysts were mixed and poured into a Brookfield viscosity cup, in a temperature chamber set at 22° C., and the measurements were taken at the time intervals. The formulas used are given below:

TABLE 11
C3DM1-86

| | Amount(g) |
|---|---|
| A-side | |
| PL2010 TDI | 16.04 |
| prepolymer | |
| B-side | |
| Ethacure ™ 100 | 1.56 |
| Dabco ™ 33LX | 0.049 |

TABLE 12
C3DM1-102

| | Amount(g) |
|---|---|
| A-side | |
| PL2010 TDI | 15.02 |
| prepolymer | |
| B-side | |
| PL2010 polyol | 3.49 |
| Ethacure ™ 100 | 1.177 |
| KKAT ™ XK-618 | 0.205 |

TABLE 13

| | Example 15 | Example 16 |
|---|---|---|
| | C3DM1-86 | C3DM1-102 |
| | Viscosity | Viscosity |
| Time (min) | (cps) | (cps) |
| 0 | 5,000 | 5,000 |
| 2 | 25,500 | 12,500 |
| 3 | 66,700 | 12,500 |
| 4 | 210,000 | 12,500 |
| 5 | 569,000 | 12,500 |
| 6 | cured | 13,333 |
| 7 | | 33,500 |
| 8 | | 48,333 |
| 10 | | 145,000 |
| 11 | | 240,000 |
| 12 | | 398,000 |

Viscometer settings: 22° C., 0.3 RPM, spindle 27.

### Example 17

### Effect of Temperature on Cure Rate

Identical samples were prepared and the viscosity growth was measured at 22° C. and 50° C. To record viscosity at the higher temperature, the initial components were heated to 50° C., mixed, and then poured into a viscometer cup with a temperature-control jacket plumbed to a circulating bath. The formulas used are given below:

TABLE 14
C3DM1-99

| | Amount(g) |
|---|---|
| A-side | |
| PL2010 TDI | 16.01 |
| prepolymer | |
| B-side | |
| Ethacure ™ 100 | 1.5732 |
| KKAT ™ XK618 | 0.0855 |

TABLE 15
C3DM1-100

| | Amount(g) |
|---|---|
| A-side | |
| PL2010 TDI | 18.015 |
| prepolymer | |
| B-side | |
| Ethacure ™ 100 | 1.7853 |
| KKAT ™ XK618 | 0.1222 |

TABLE 16

| | C3DM1-99 | |
|---|---|---|
| | 22° C. Viscosity | C3DM1-100 |
| Time (min) | (cps) | 50° (cps) |
| 2 | | 36,500 |
| 2.5 | 39,167 | 56,600 |
| 3 | 40,000 | 85,000 |
| 4 | 41,667 | 112,000 |
| 5 | 86,333 | 278,000 |
| 6 | 142,000 | 534,000 |
| 7 | 250,000 | cured |
| 8 | 459,000 | |
| 9 | 793,000 | |

Viscometer settings: 22° C., 0.3 RPM, spindle 27. The prepolymer for formula C3DM1-100 was heated to 50° C. before use.

### Example 18

### Example of Effect of Different Isocyanate Prepolymers on Cure Rate

Two isocyanate formulas were reacted with an identical polyol formula. The isocyanate formula for C3DM4-50 had 20% TDI (toluene di-isocyanate) and 80% Pluracol 1010 TDI prepolymer. The isocyanate formula for C3DM4-28 had 20% monomeric MDI and 80% Pluracol 1010 MDI prepolymer. Each were mixed with a 5% stoichiometric excess of the polyol formula.

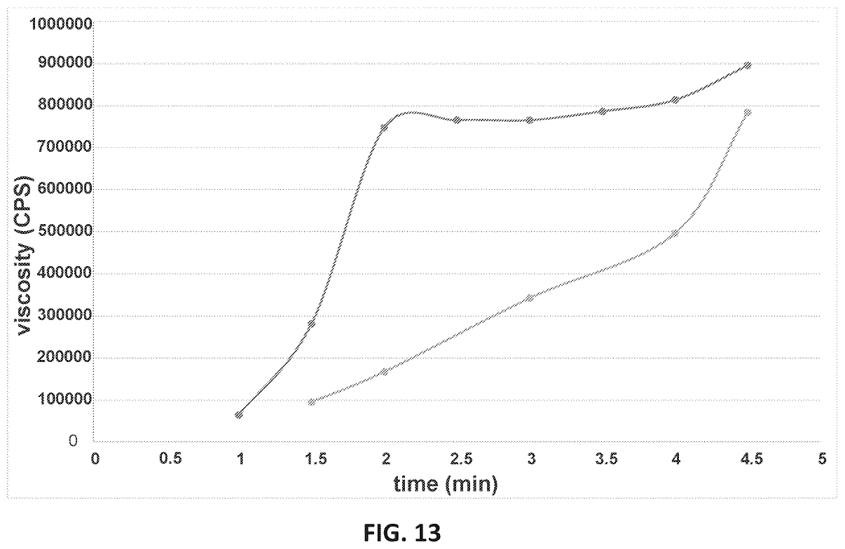

The isocyanate groups on TDI do not have equivalent reactivities, whereas the isocyanate groups on MDI have equivalent reactivity. It was observed that the TDI-based formula had a rapid increase in viscosity, followed by a plateau, whereas the MDI-based formula had a more steady increase in viscosity (FIG. 13). The formulas used are given below:

TABLE 17
C3DM4-50

| | Amount(g) |
|---|---|
| A-side | |
| PL1010 TDI | 24.03 |
| prepolymer | |
| TDI | 6.01 |
| B-side | |
| PL1010 polyol | 19.77 |
| Polyol Prepolymer 2 | 10.67 |
| Ethacure 100 | 0.88 |
| Ethacure 300 | 3.69 |
| KKAT XK618 | 0.19 |

TABLE 18
C3DM4-28

| | Amount (g) |
|---|---|
| A-side | |
| PL1010 MDI | 12.05 |
| prepolymer | |
| MDI | 3.03 |
| B-side | |
| PL1010 polyol | 7.99 |
| Polyol Prepolymer 1 | 4.31 |
| Ethacure ™ 100 | 0.36 |
| Ethacure ™ 300 | 1.49 |
| KKAT ™ XK618 | 0.11 |

### Examples 19

### Printability and Mixer Residence Time

In this example, we demonstrate how the viscosity growth rate of two partially reacted thermosets interact with the volumetric flow rate and volume of the mixer to define a set of flow rates for which the partially reacted thermosets are printable. Both formulas produce a polymer with a Shore A hardness of approximately 50. The formulas used are given below:

TABLE 19
Fast Formula

| Isocyanate | Wt % | | Polyol | Wt % | |
|---|---|---|---|---|---|
| Lupranate ™ MI | 20 | | Ethacure ™ 100 | 8.5 | |
| PI1010 MDI | 80 | | Pluracol ™ 1010 | 59 | |
| prepolymer | | | | | |
| | | | Polyol prepolymer 2 | 32 | |
| | | | Dabco ™ T12 | 0.25 | |
| | | | Dabco ™ 33LX | 0.25 | |
| Starting viscosity | 5300 | cP | | 2660 | cP |
| Spindle 27, 6 RPM | 25° | C. | | 20° | C. |

TABLE 20
Slow Formula

| Isocyanate | Wt % | | Polyol | Wt % | |
|---|---|---|---|---|---|
| Lupranate ™ MI | 20 | | Ethacure ™ 100 | 3.5 | |
| | | | Ethacure ™ 300 | 7.0 | |
| PI1010 MDI | 80 | | Pluracol ™ 1010 | 58 | |
| prepolymer | | | | | |
| | | | Polyol prepolymer 2 | 31 | |
| | | | KKat ™ XK-618 | 0.5 | |
| Starting viscosity | 5300 | cP | | 2500 | cP |
| Spindle 27, 6 RPM | 25° | C. | | 20° | C. |

The fast formula system cures too quickly to measure viscosity growth. In the 30 seconds that it takes to mix, the material solidifies too much to pour into the viscometer cup.

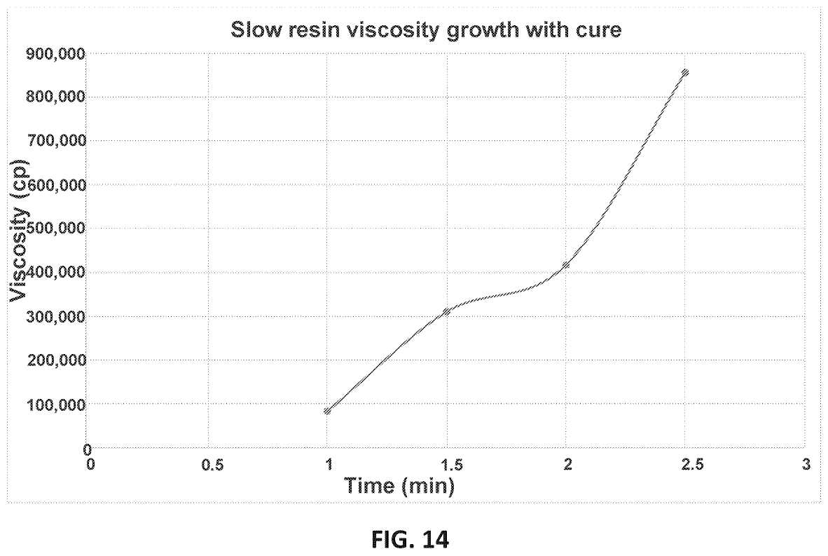

The viscosity growth of the slow formula system is shown in FIG. 14. The viscosity increases two orders of magnitude, to approximately 1,000,000 cps, in 3 minutes. Viscometer settings: 22° C., spindle 27, 0.3 RPM.

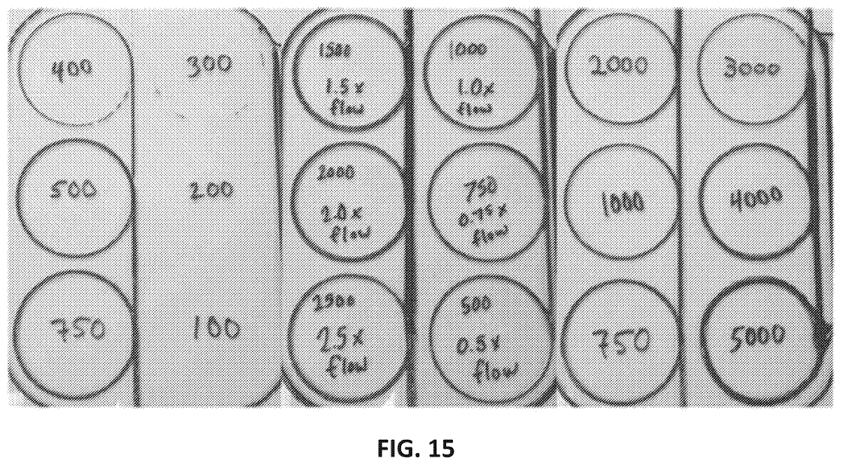

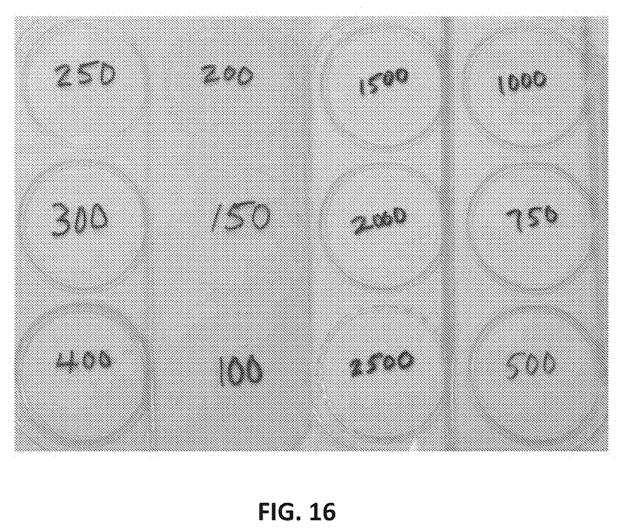

To illustrate the processing window of the formulas, we printed a single layer circle at various flow rates (FIG. 15 and FIG. 16). The two components had a mix ratio of 1:1, and were pumped through a static mixer nozzle with a volume of 250 μL. For the fast formula, below 500 mm/min (FIG. 15, upper circle in column 1, and all circles in column 2) (400 μL/min, 37.5 sec residence time) the flow stops, and above 2500 mm/min (FIG. 15, lower circle in column 3 and all circles in the 6^{th} column) (2000 μL/min, 7.5 sec residence time), the line thickness varies and then spreads. The fast formula had a processing window spanning residence times ranging from 7.5-37.5 seconds. For the slow formula, below 250 mm/min (FIG. 16, upper circle in column 1 and all circles in column 2) (200 μL/min, 75 sec residence time), the flow stops, and above 2000 mm/min (FIG. 16, middle circle in column 3 and lower circle in column 4) (1,600 μL/min, 9.4 sec residence time), the line thickness varies. The slow formula had a broader processing window spanning 9.4-75 seconds.

### Example 20

### Multi-Layer Printing

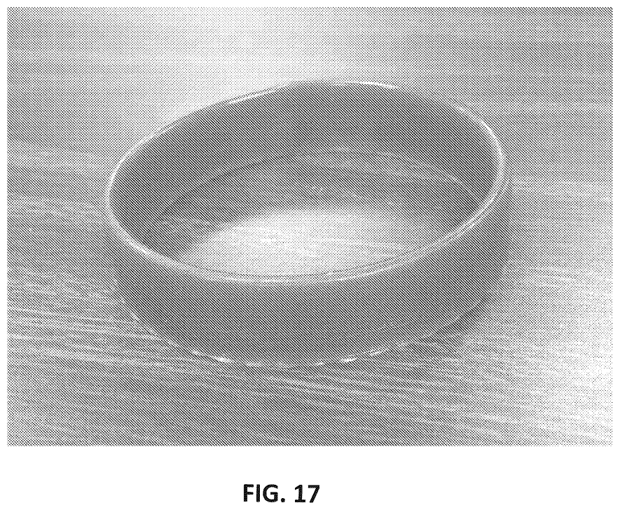

Formula C3DM4-71 was printed on a Hyrel™ 3D printer. The printer parameters were set such that material was pumped through the mixer at 1296 μL/min. The mixer had a volume of approximately 250 μL, and a tip nozzle diameter of 0.8 mm. Three adjacent concentric circles were deposited on the printing surface, and subsequent layers were continually deposited for a total of 29 layers (FIG. 17). After the printing process, the structure was heated in a 50° C. oven for 30 minutes. The formula used is given below:

TABLE 21
C3DM4-71

| | Amount(g) |
|---|---|
| A-side | |
| PL1010 MDI | 80 |
| prepolymer | |
| MDI | 20 |
| B-side | |
| PL1010 polyol | 71.17 |
| Polyol prepolymer 1 | 20.63 |
| Ethacure ™ 100 | 4.18 |
| Ethacure ™ 300 | 7.33 |
| KKAT ™ XK618 | 0.70 |

### Example 21

### Foam Printing

Formula C3DM4-64 was printed on a Hyrel 3D printer. The printer parameters were set such that material was pumped through the mixer at 450 μL/min. The mixer had a volume of approximately 1000 μL and a tip nozzle diameter of 1.75 mm. Three adjacent concentric circles were deposited on the printing surface, and subsequent layers were continually deposited for a total of 70 layers. As the layers were deposited, lower layers foamed and expanded. The formula used is given below:

TABLE 22
Formula C3DM4-64

| Isocyanate | Wt % | Polyol | Wt % |
|---|---|---|---|
| Lupranate ™ MI | 40 | Ethacure ™ 300 | 2.1 |
| Pluracol ™ 1010 MDI | 60 | Ethacure ™ 100 | 2.1 |
| prepolymer | | water | 4 |
| | | Pluracol ™ 2010 | 16.75 |
| | | Pluracol ™ 1135i | 75 |
| | | Stannous Octanoate | 0.6 |
| | | Dabco ™ DC 5043 | 0.4 |

### Example 22

### Print Parameter Effects on Part Geometry

A hollow cylinder of formula C3DM4-105 was printed by continuously depositing a single circle of material on a printing platform. A Sulzer Mixpac Statomix™ EA3.0-13SA 13 element static mixer was attached to a 1:1 dual cartridge which was controlled by the printer. For each part, 20 layers were deposited. Parameters such as the time per layer and the volumetric flow rate of the partially reacted thermoset product were seen to impact the final part geometry. These parameters can be controlled to achieve the desired part resolution.

TABLE 23

| | Printhead | | | | volumetric |
|---|---|---|---|---|---|
| Band | Linear | Part | Band | Time Per | flow rate |
| Diameter | Speed | Height | Thickness | Layer | (microliter/ |
| (mm) | (mm/min) | (mm) | (mm) | (sec) | sec) |
| 100 | 800 | 7.9 | 4.2 | 25 | 86.4 |
| 100 | 500 | 9.6 | 3.2 | 38 | 54 |
| 100 | 350 | 11.2 | 2.9 | 54 | 37.8 |
| 100 | 250 | 11.7 | 2.6 | 75 | 27 |
| 90 | 350 | 10.8 | 3.0 | 49 | 37.8 |
| 80 | 350 | 10.3 | 3.0 | 45 | 37.8 |
| 70 | 350 | 10.0 | 3.2 | 38 | 37.8 |
| 60 | 350 | 9.8 | 3.4 | 33 | 37.8 |
| 50 | 350 | 9.0 | 3.6 | 27 | 37.8 |
| 30 | 350 | 7.3 | 4.6 | 17 | 37.8 |
| 20 | 350 | 6.1 | Flowed part | 11 | 37.8 |
| 10 | 350 | 4.5 | Flowed part | 6 | 37.8 |

TABLE 24
Formula C3DM4-105

| Isocyanate | Wt % | Polyol | Wt % |
|---|---|---|---|
| Lupranate ™ MI | 20 | Ethacure ™ 300 | 7.0% |
| Pluracol ™ 1010 MDI | 80 | Ethacure ™ 100 | 4.0% |
| prepolymer | | | |
| | | Pluracol ™ 1010 | 66.8% |
| | | Pluracol ™ 1135i | 10.0% |
| | | Polyol Prepolymer 1 | 12.0% |
| | | KKat ™ XK-618 | 0.2% |

### Example 23

### Part Density

Formula C3DM8-49 was extruded onto a rectangular mold using a 3M Scotch-Weld EPX Plus II™ Manual Applicator. The rectangular part cured at room temperature for 48 hours, and then was cured in an oven at 60° C. for 6 hours. A part was cut from the sample, was weighed for mass, and then volume was measured by displacement of water in a volumetric flask. Density was recorded as mass divided by volume. The density of the part was 1.12+/−0.01 g/mL.

Formula C3DM8-49 was printed using a Hyrel™ printer with a 250 μL mixing volume tip with a 0.8 mm nozzle diameter. The printed part dimensions were a 50.8 mm×127 mm×3 layers. The line widths were set to 1.6 mm, and were printed with paths separated by 1.0 mm. The translation speed was 1,000 mm/min and the flow multiplier was set to 3.0. The density of the part was 1.12+/−0.01 g/mL.

### Example 24

### Formula Variations to Achieve Changes in Part Hardness

The formulas in Table 25 were formulated to with a fixed number of ingredients to achieve a range of Shore A Hardnesses.

TABLE 25

| Formula Name | C3DM8-47 | C3DM8-36 | C3DM8-51 | C3DM8-41 | C3DM8-58 |
|---|---|---|---|---|---|
| Shore A Hardness | 36 | 37 | 50 | 64 | 90 |
| A:B Volumetric Ratio | 1:1 | 1:1 | 1:1 | 1:1 | 1:1 |
| | Amount | Amount | Amount | Amount | Amount |
| | (wt %) | (wt %) | (wt %) | (wt %) | (wt %) |
| A-side | | | | | |
| PL1010 MDI | | 90.0 | | 80.0 | 65.0 |
| prepolymer | | | | | |
| PL2010 MDI | 80.0 | | 80.0 | | |
| prepolymer | | | | | |
| Lupranate ™ MI | 20.0 | 10.0 | 20.0 | 20.0 | 35.0 |
| B-side | | | | | |
| PL1010 polyol | 65.9 | 62.5 | 52.0 | 60.5 | 46.3 |
| PL2010 polyol | | 20.2 | 10.0 | | |
| Pluracol ™ 1135i | 7.9 | | 10.0 | 9.9 | |
| Polyol | 20.9 | 12.2 | 21.2 | 17.9 | 28.6 |
| Prepolymer 2 | | | | | |
| Ethacure ™ 100 | 3.0 | 5.0 | 5.0 | 4.5 | |
| Ethacure ™ 300 | 2.0 | | 1.5 | 6.9 | 25 |
| Color | 0.2 | | 0.2 | 0.2 | |
| KKAT ™ XK618 | 0.1 | 0.1 | 0.1 | 0.1 | 0.1 |

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A three-dimensional (3D) object production system comprising:
extruded thermoset printing apparatus comprising:
an extrusion nozzle to deliver a thermoset product from a to form a 3D object,
a mixing chamber to receive and mix at least a first reactive component, a second reactive component, and a third reactive component to provide the thermoset product, and
metering apparatus to control at least an amount and a flow rate of the first reactive component, the second reactive component, and the third reactive component into the mixing chamber; and
a controller comprising one or more processors and operably coupled to the extruded thermoset printing apparatus, wherein the controller is configured to:
receive a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area, and
produce the 3D object using the extruded thermoset printing apparatus based on the 3D object design by adjusting one or both of the amount and flow rate of one or more of the first, second, and third reactive components to provide the thermoset product for the first area of the 3D object design to provide the physical property of the first area that is different than the same physical property of the second area.

2. The system according to claim 1, wherein the physical property is flexibility, color, optical refractive index, hardness, porosity or density.

3. The system according to claim 1, wherein the physical property is flexibility, porosity or hardness.

4. The system according to claim 2, wherein the controller is further configured to execute: adjusting one or both of an amount and a flow rate of a gas-generation source for use with one or more of the first, second, and third reactive components to provide the thermoset product for the first area of the 3D object design to provide the physical property of the first area that is different than the same physical property of the second area.

5. The system according to claim 1, wherein the 3D object design comprises an area defining a geometry, wherein the one or more parameters are adjusted to form the area based on the defined geometry.

6. The system according to claim 1, wherein the 3D object design comprises an area defining a fill property, wherein the one or more parameters are adjusted to form the area based on the defined fill property.

7. A three-dimensional (3D) object production system comprising:
a controller comprising one or more processors and configured to:
receive a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area, and
generate one more extruded thermoset printing processes to produce the 3D object based on the 3D object design by adjusting one or both of the amount and flow rate of one or more of first, second, and third reactive components to provide a thermoset product for the first area of the 3D object design to provide the physical property of the first area that is different than the same physical property of the second area.

8. The system according to claim 7, wherein the physical property is flexibility, color, optical refractive index, hardness, porosity or density.

9. The system according to claim 7, wherein the physical property is flexibility, porosity or hardness.

10. The system according to claim 7, wherein the controller is further configured to execute: adjusting one or both of an amount and a flow rate of a gas-generation source for use with one or more of the first, second, and third reactive components to provide the thermoset product for the first area of the 3D object design to provide the physical property of the first area that is different than the same physical property of the second area.

11. The system according to claim 7, wherein the 3D object design comprises an area defining a geometry, wherein the one or more parameters are adjusted to form the area based on the defined geometry.

12. The system according to claim 7, wherein the 3D object design comprises an area defining a fill property, wherein the one or more parameters are adjusted to form the area based on the defined fill property.

13. A three-dimensional (3D) object production method comprising:
receiving a 3D object design to be produced into a 3D object using thermoset product delivered by the extruded thermoset printing apparatus, wherein the 3D object design comprises a first area and a second area in a different location than the first area, wherein a physical property of the first area is different than the same physical property of the second area; and
generating one more extruded thermoset printing processes to produce the 3D object based on the 3D object design by adjusting one or both of the amount and flow rate of one or more of first, second, and third reactive components to provide a thermoset product for the first area of the 3D object design to provide the physical property of the first area that is different than the same physical property of the second area.

14. The method according to claim 13 further comprising carrying out the method using an extruded thermoset printing apparatus comprising:
an extrusion nozzle to deliver a thermoset product from a to form a 3D object,
a mixing chamber to receive and mix at least a first reactive component, a second reactive component, and a third reactive component to provide the thermoset product, and
metering apparatus to control at least an amount and a flow rate of the first reactive component, the second reactive component, and the third reactive component into the mixing chamber.

15. The method according to claim 13, wherein the physical property is flexibility, color, optical refractive index, hardness, porosity or density.

16. The method according to claim 13, wherein the physical property is flexibility, porosity or hardness.

17. The method according to claim 13, wherein the 3D object design comprises an area defining a geometry, wherein the one or more parameters are adjusted to form the area based on the defined geometry.

18. The method according to claim 13, wherein the 3D object design comprises an area defining a fill property, wherein the one or more parameters are adjusted to form the area based on the defined fill property.
